(19) United States
(12) Patent Application Publication
(10) Pub. No.: US 2026/0146176 A1
(43) Pub. Date: May 28, 2026

(54) INK SET, INK JET RECORDING METHOD AND INK JET RECORDING APPARATUS

(71) Applicant: CANON KABUSHIKI KAISHA, Tokyo (JP)

(72) Inventors: KANAKO HIGUCHI, Kanagawa (JP); AKIHIRO TAYA, Kanagawa (JP); HIDETAKA KAWAMURA, Kanagawa (JP); YUKO KATSUMOTO, Kanagawa (JP); AKIO KASHIWAZAKI, Kanagawa (JP); JUNJI ITO, Kanagawa (JP); WAKA HASEGAWA, Tokyo (JP); HIROSHI ASAKAWA, Kanagawa (JP); MAMIKO KAJI, Kanagawa (JP); SATOSHI YAMABI, Kanagawa (JP)

(21) Appl. No.: 19/388,863

(22) Filed: Nov. 13, 2025

(30) Foreign Application Priority Data
Nov. 22, 2024 (JP) 2024-203847
Oct. 22, 2025 (JP) 2025-177996

(51) Int. Cl. C09D 11/40; B41J 2/21; B41J 11/00; B41M 3/00; B41M 7/00; C09D 11/037; C09D 11/322; C09D 11/38; C09D 11/54

(52) U.S. Cl. CPC C09D 11/40; B41J 2/2117; B41J 11/0022; B41J 11/0024; B41M 3/001; B41M 7/009; C09D 11/037; C09D 11/322; C09D 11/38; C09D 11/54

(57) ABSTRACT

An ink set for ink jet recording includes a white aqueous ink containing titanium oxide and a resin particle and a reaction liquid containing a reactant that reacts with the aqueous ink. The aqueous ink further contains a water-soluble resin including a unit having an acidic group. The proportion (mol %) of the unit having an acidic group in the water-soluble resin is 60.0 mol % or more, and the unit having an acidic group includes a unit having a plurality of carboxylic acid groups, and the reactant includes a polyvalent metal salt.

### BACKGROUND

### Field of the Technology

The present disclosure relates to an ink set, an ink jet recording method and an ink jet recording apparatus.

### Description of the Related Art

In recent years, it has been investigated to expand ink jet recording methods to the fields of commercial and industrial printing. In these fields, in addition to black, cyan, magenta and yellow inks (hereinafter, referred to as “color inks”), white inks may be used. White inks are used when a white image is recorded on a recording medium with a color other than white, such as colored paper or when a white image is recorded as a background color for color inks on a recording medium such as transparent or translucent film. From the viewpoint of material stability and cost, white pigments such as titanium oxide are used in white inks. When a white image is recorded, it is necessary to apply a large amount of a white ink, compared to color inks, in order to enhance the concealing property and whiteness of the image. Accordingly, an ink jet recording apparatus using a white ink may be equipped with a drying mechanism.

When commercial or industrial printing is realized by an ink jet recording method, the image to be recorded is required to have high abrasion resistance. Addition of a resin particle to an ink is useful for improving abrasion resistance, and the addition of a resin particle to a white ink is also being considered. The resin particle in the ink applied to a recording medium fuses by decrease and drying of the liquid component and forms a resin film, which suppresses peeling of the coloring material and improves abrasion resistance.

When an image is recorded on a low-absorbent recording medium such as printing paper or on a non-absorbent recording medium such as a resin film, since the ink tends to move on the recording medium, variation in the thickness of the recorded image (a so-called film thickness unevenness) tends to arise. When an image is recorded on an absorbent recording medium such as plain paper, local variation in the permeability of the ink occurs due to the influence of the fibers constituting the recording medium, and film thickness unevenness tends to occur. In order to reduce the film thickness unevenness of an image, for example, a set including an ink and a process liquid containing an aggregating agent for aggregating the coloring material in an ink and a recording method for recording an image using such a set have been proposed (Japanese Patent Laid-Open Nos. 2020-189897 and 2021-187095).

However, for example, when a recording apparatus equipped with a drying mechanism for promoting drying of an image by a method such as blowing air to the recording medium is used, a white ink on the recording medium easily moves by the air flow. Consequently, even if the set proposed in Japanese Patent Laid-Open No. 2020-189897 or 2021-187095 is used, it is difficult to sufficiently reduce the film thickness unevenness of the image to be recorded.

### SUMMARY

Accordingly, the present disclosure provides an ink set for ink jet recording that can record a white image with reduced film thickness unevenness. The present disclosure also provides an ink jet recording method using the ink set and an ink jet recording apparatus.

That is, according to the present disclosure, provided is an ink set for ink jet recording including a white aqueous ink containing titanium oxide and a resin particle and a reaction liquid containing a reactant that reacts with the aqueous ink, wherein the aqueous ink further contains a water-soluble resin including a unit having an acidic group, the proportion (mol %) of the unit having an acidic group in the water-soluble resin is 60.0 mol % or more, the unit having an acidic group includes a unit having a plurality of carboxylic acid groups, and the reactant includes a polyvalent metal salt.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view schematically illustrating an embodiment of the ink jet recording apparatus of the present disclosure.

FIG. 2 is a side view schematically illustrating an embodiment of the ink jet recording apparatus of the present disclosure.

### DESCRIPTION OF THE EMBODIMENTS

The present disclosure will be described in further detail with reference to preferred embodiments below. In the present disclosure, when a compound is a salt, the salt in an ink is dissociated and exists as ions, but for convenience, it is expressed as “containing a salt”. An aqueous ink and a reaction liquid for ink jet recording may be simply referred to as “ink” and “reaction liquid”, respectively. Titanium oxide as a coloring material of a white ink may be referred to as a pigment. Physical property values are values at normal temperature (25° C.), ordinary humidity (relative humidity: 50%) and normal pressure (1 atm), unless otherwise specified.

Firstly, the present inventors investigated method for reducing film thickness unevenness of the image. Some of ink jet recording apparatuses using white inks are equipped with a drying mechanism that promotes drying of the image by a method such as blowing air, e.g., hot air, to the recording medium. In this case, the white ink on the recording medium tends to move by the air blown by the drying mechanism, and film thickness unevenness tends to occur in the image. It is inferred that in order to reduce the film thickness unevenness, the pigment is required to precipitate before the recording medium applied with an ink and a reaction liquid is transported to the drying mechanism.

The precipitation speed V of the particle in an ink can be calculated by the following equation (A) (Stokes' equation):

$$V = \{ g ( {ρ}_{s} - ρ ) {d}^{2} \} / 18 μ , \qquad ( A )$$

$$d : particle size ;$$

$$g : gravitational acceleration ;$$

$${ρ}_{s} : density of particle ;$$

$$ρ : density of dispersion medium ; and$$

$$μ : viscosity of dispersion medium .$$

According to the Stokes' equation, it is demonstrated that the larger the particle size or the greater the density, the easier the particle is to precipitate. Because of this, on a low- to non-absorbent recording medium into which inks hardly permeate, the precipitation speed of a pigment in a dot is increased by using a reaction liquid together with the white ink containing the pigment that has a large particle size and can form a higher density aggregate. Consequently, film thickness unevenness that occurs due to the movement of the ink can be reduced. In addition, on an absorbent recording medium into which an ink easily permeates, the size of the aggregate is increased by using a reaction liquid together with a white ink containing a pigment that has a large particle size, and the permeation in the depth direction of the recording medium is suppressed. Consequently, even if there is local variation in the permeability of the ink due to the influence of the fibers constituting the recording medium, it is possible to reduce the film thickness unevenness that occurs due to the variation. Regardless of the permeability of the recording medium, the precipitation speed of the pigment increases, and thereby the particle tends to uniformly accumulate on the surface of the recording medium, and film thickness unevenness can be more effectively suppressed.

Secondly, the present inventors investigated the combination of a pigment that can form a high-density aggregate and a reactant. It is inferred that in order to form a high-density aggregate, it is necessary to increase the crosslink density between pigment particles. Specifically, it was found that the precipitation speed of the pigment is increased by adding a water-soluble resin including a carboxylic acid group at a high density to an ink and using a polyvalent metal salt having a high aggregation property as the reactant, and a high-density aggregate is formed.

Furthermore, the present inventors investigated the configuration of an ink set that can record an image with reduced film thickness unevenness by forming a high-density aggregate through an increase in the precipitation speed of the pigment. As a result, it was found that an image with reduced film thickness unevenness can be recorded by satisfying the following requirements (i) to (iv), and the present disclosure was accomplished.
(i) a white aqueous ink containing titanium oxide and a resin particle and a reaction liquid containing a reactant that reacts with an aqueous ink are used in combination;
(ii) the aqueous ink contains a water-soluble resin including a unit having an acidic group;
(iii) the proportion (mol %) of the unit having an acidic group in the water-soluble resin is 60.0 mol % or more, and the unit having an acidic group includes a unit having a plurality of carboxylic acid groups; and
(iv) the reactant contains a polyvalent metal salt.

The present inventors presumed the reason why an image with reduced film thickness unevenness can be recorded by satisfying the above requirements as follows. At least a part of the acidic groups included in the unit having an acidic group can be ionically dissociated depending on the acid dissociation constant (pKa). The thickness of the electric double layer decreases by adding a polyvalent metal salt to an ink, the electrostatic repulsion is weakened, and the pigment aggregates. On this occasion, it is inferred that the anion generated by ionic dissociation crosslinks with the polyvalent metal ion derived from the polyvalent metal salt and that the acidic groups that are not ionically dissociated are hydrogen bonded between a plurality of acidic groups. Since the water-soluble resin includes a plurality of carboxylic acid groups, the density of the carboxylic acid group in the unit is high. In general, within a pH range of about 7.0 to 9.0 which is a common pH of aqueous inks for ink jet recording, at least a part of the carboxylic acid groups of the water-soluble resin is ionically dissociated and becomes a carboxylate ion. The carboxylate ion reacts with the polyvalent metal ion and forms a stable carboxylate complex, and the acidic groups that are not ionically dissociated are hydrogen bonded between a plurality of acidic groups. Accordingly, since the densities of the carboxylic acid group and the carboxylate ion that contribute to the aggregation of the particle become high by adding a polyvalent metal salt to an ink containing a water-soluble resin including a unit having a plurality of carboxylic acid groups, the crosslink density of the pigment is increased. Consequently, it is inferred that since the density of the aggregate of the pigment increases and thereby the precipitation speed is increased, the occurrence of the film thickness unevenness due to the movement of the ink can be suppressed.

The evaporation speed Qₑᵥₐₚ of an aqueous liquid component in an ink can be calculated by the following equation (B):

$${Q}_{evap} = k ( {Y}_{w} - {Y}_{a} ) , \qquad ( B )$$

$$k : mass transfer coefficient [ m / s ] ;$$

$${Y}_{w} : saturated steam volume [ kg / {m}^{3} ] ( calculated as wet bulb temperature ) ;$$

$${Y}_{a} : water vapor amount [ kg / {m}^{3} ] ( calculated from temperature and relative humidity ) ;$$

$$Sherwood number ( Sh = kL / D , k : mass transfer coefficient [ m / s ] , L : model length [ m ] , D : diffusion coefficient [ {m}^{2} / s ] ) ;$$

$$Schmidt number ( Sc = μ / ( ρ D ) , μ : viscosity coefficient [ Pa \cdot s ] , ρ : density [ kg / {m}^{3} ] , D : diffusion coefficient [ {m}^{2} / s ] ) ; and$$

Reynolds number (Re=ρνL/μ, ρ: density [kg/m³], ν: wind speed [m/s], L: model length [m], μ: viscosity coefficient [Pa·s]).

Each value of the equation (B) is calculated from the Sherwood number, Schmidt number and Reynolds number, and the resulting values are substituted into the equation (B). On this occasion, the recording duty of an image recorded under a condition of applying 8 ink droplets with a mass of 3.5 ng per droplet to a unit area of 1/600 inch× 1/600 inch is defined as 100%. The evaporation speed of the liquid component is 1.046×10⁻⁵ g/s when the ink is applied to an area of 1 inch×1 inch at a temperature of 25° C., a relative humidity of 50% and a wind speed of 1 m/s such that the recording duty is 100%. On this occasion, the film thickness reduction rate in the area of 1 inch×1 inch is determined as 1.1×10⁻⁵ cm/s.

As is described above, the precipitation speed of the particle (titanium oxide) in an ink is calculated by the above equation (A). The particle size of the titanium oxide on the order of nm before aggregation reaches the order of m by aggregation due to the contact of the ink and a reaction liquid with each other. As a rule of thumb, it is known that the density of aggregate is proportional to 0.4 times the crosslink density. For example, if the number of acidic groups of the water-soluble resin is increased by 1.25 times, the density of aggregate of titanium oxide aggregated by being involved in aggregation of the water-soluble resin will be increased by 1.1 times. Therefore, the precipitation speed of the titanium oxide with a particle size of about 1 m after aggregation is determined as follows. That is, when the proportion of the unit having an acidic group in the water-soluble resin is 50.0 mol %, the precipitation speed is 9.8×10⁻⁶ cm/s, and when the proportion is 60.0 mol %, the precipitation speed is 1.2×10⁻⁵ cm/s.

That is, if the proportion of the unit having an acidic group in the water-soluble resin is 60.0 mol % or more, the precipitation speed of the aggregate of titanium oxide is greater than the evaporation speed of the liquid component in the ink. Consequently, it is possible to suppress the occurrence of film thickness unevenness due to the movement of the ink.

In order to form high-density aggregate, it is necessary to use a water-soluble resin in which the proportion of the unit having an acidic group is 60.0 mol % or more and the unit having an acidic group includes a unit having a plurality of carboxylic acid groups. In contrast, if the proportion of the unit having an acidic group in the water-soluble resin is less than 60.0 mol % or if the water-soluble resin does not contain a unit having a plurality of carboxylic acid groups, the density of aggregate cannot be increased. Accordingly, the pigment does not promptly precipitate after application of the ink to a recording medium, and film thickness unevenness tends to occur.

Since the polyvalent metal salt used as the reactant has a low molecular weight compared to a cationic resin or organic acid that is similarly used as a reactant, the reactant easily moves. In addition, the polyvalent metal salt is easily dissolved in water and easily generates a cationic component that causes aggregation of the pigment. Accordingly, when a reaction liquid containing a polyvalent metal salt as a reactant is applied to a recording medium and an ink is further applied thereto, the cationic component promptly moves all over the ink droplet to aggregate the pigment. Accordingly, when the polyvalent metal salt is used as a reactant, it is possible to aggregate titanium oxide more promptly, compared to when a cationic resin or an organic acid is used as a reactant.

### Ink Set

The ink set of the present disclosure is an ink set for ink jet recording including a white ink containing titanium oxide and a resin particle and a reactant that reacts the ink. The ink further contains a water-soluble resin including a unit having an acidic group, the proportion (mol %) of the unit having an acidic group in the water-soluble resin is 60.0 mol % or more, and the unit having an acidic group includes a unit having a plurality of carboxylic acid groups. The reactant includes a polyvalent metal salt.

The ink set form is, for example, a set constituted of a plurality of ink cartridges each independently storing an ink and a reaction liquid. Alternatively, the ink set form is also an ink cartridge integrally constituted of a plurality of ink storing units constituted of respectively storing an ink and a reaction liquid. The ink set of the present disclosure is not limited to the above forms and may be in any form as long as it is constituted so that an ink and a reaction liquid can be used in combination.

### Ink

The ink is a white ink for ink jet recording containing titanium oxide and a resin particle. The white ink also includes an ink that can record a white image although the color in the ink state is not white. The white color means that lightness (L*) and chromaticity (a*, b*) are within ranges of 70≤L*≤100, −4.5≤a*≤2 and −6≤b*≤2.5, respectively. Components and so on constituting the ink will be described in detail below.

### Titanium Oxide

The ink contains titanium oxide particles. The content (mass %) of the titanium oxide in the ink is preferably 0.1 mass % or more to 45.0 mass % or less and further preferably 5.0 mass % or more to 38.0 mass % or less based on the total mass of the ink.

Titanium oxide is usually dispersed in an ink in a state of secondary aggregate (secondary particle) formed by aggregation of two or more primary particles. The average primary particle size D_{P0} (nm) of the titanium oxide contained in the ink is preferably 150 nm or less, further preferably 50 nm or less, and particularly preferably 30 nm or less. The average primary particle size D_{P0} (nm) of the titanium oxide is preferably 5 nm or more. The primary particle size of the titanium oxide can be measured by observing the titanium oxide particles using a scanning electron microscope. The average primary particle size D_{P0} (nm) of the titanium oxide can be calculated as the average value of the primary particle sizes of a plurality of particles (for example, 100 particles).

The “average particle size (nm)” in the present specification means “50% cumulative particle size (nm) in a volume-based particle size distribution”. The 50% cumulative particle size (nm) (average particle size (nm)) in volume-based particle size distribution is the diameter of the particle at 50% calculated from the smallest particle size side in a particle size accumulation curve measured based on the total volume of the particles. The average particle size (nm) can be measured using a particle size distribution measurement apparatus by a dynamic light scattering method. Examples of the measurement conditions include SetZero: 30 seconds, number of measurement: 3 times, measurement time: 180 seconds and shape: aspherical. As the particle size distribution measurement apparatus, for example, a particle size analyzer (for example, trade name “UPA-EX150”, manufactured by Nikkiso Co., Ltd.) by a dynamic light scattering method can be used. Needless to say, the particle size distribution measurement apparatus to be used, measurement conditions, and so on are not limited to the above.

The average particle size D_{P} (nm) of the titanium oxide is preferably 500 nm or less and further preferably 400 nm or less and is preferably 5 nm or more.

A porous film having holes can be formed using titanium oxide having an average particle size D_{P} (nm) of 150 nm or less, and an image with an excellent concealing property can be recorded. When titanium oxide having a small average particle size is used, gaps are formed between particles of the titanium oxide aggregated by the reaction liquid. Subsequently, the recording medium is heated to a temperature at which the resin particle fuses (a temperature equal to or higher than the glass transition temperature Tg (° C.) or melting point T_{M} (° C.) of the resin particle), and the resin made of the fused resin particle permeates into gaps by the capillary force. At the same time, holes are formed at the positions where the resin particles were present. The fused resin permeates into the gaps, and thereby a binder that is a mixture of the titanium oxide and the resin is formed. Even if the titanium oxide having an average particle size D_{P} (nm) of 150 nm or less is used, incident visible light is hardly scattered when the above-mentioned resin particle is not used in combination. However, it is inferred that when the resin particle is fused as is described above, air with a low refractive index is present in the formed holes, and the refractive index of the holes is relatively lower than the refractive index of the binder. Under such a circumstance, the incident visible light scatters due to the difference between the refractive indices of the binder and the hole. Consequently, it is inferred that an image with an improved concealing property is recorded.

The refractive index of the titanium oxide is preferably 2.1 or more and further preferably 2.5 or more and 2.8 or less. The particle surface of the titanium oxide may be coated with an inorganic oxide such as alumina, silica, zinc oxide and zirconia; or organic material such as polyol. It is expected to suppress the photocatalytic activity and improve the dispersibility by using the titanium oxide with a coated particle surface. Titanium oxide has three crystal forms of a rutile type, an anatase type and a brookite type. In particular, it is preferable to use rutile-type titanium oxide having a low photocatalytic activity. Examples of the method for industrially manufacturing titanium oxide include a sulfuric acid method and a chlorine method. Titanium oxide produced by any of the manufacturing methods can be used.

### Resin Particle

The ink contains a resin particle. The resin particle is effective for improving the abrasion resistance of the image. The resin particle does not necessarily contain a coloring material. The content (mass %) of the resin particle in the ink is preferably 1.0 mass % or more to 50.0 mass % or less and further preferably 2.5 mass % or more to 15.0 mass % or less based on the total mass of the ink.

The “resin particle” in the present specification means a resin that is present in a state of insoluble in the aqueous medium in the ink, more specifically, a resin that can exist in an aqueous medium in a state of a particles with a particle size that can be measured by a dynamic light scattering method. In contrast, the “water-soluble resin” means a resin that is present in a state of being dissolved in the aqueous medium in the ink.

Whether a resin corresponds to either a “resin particle” or a “water-soluble resin” can be judged according to the method shown below. A liquid containing a resin as a target to be judged is provided and is diluted with pure water so that the content of the resin is about 1.0% to prepare a sample. Then, when the particle size of the resin in the sample is measured by a dynamic light scattering method, if a particle having a particle size is measured, the resin is judged to be a “resin particle” (i.e., “water-dispersible resin”). In contrast, if a particle having a particle size is not measured, the resin is judged not to be a “resin particle” (i.e., “water-soluble resin”). The measurement conditions on this occasion are, for example, SetZero: 30 seconds, number of measurement: 10 times, measurement time: 120 seconds, shape: true spherical, refractive index: 1.5 and density: 1.0.

As the particle size distribution measurement apparatus, for example, a particle size analyzer by a dynamic light scattering method (for example, trade name “UPA-EX150”, manufactured by Nikkiso Co., Ltd.) can be used. Needless to say, the particle size distribution measurement apparatus to be used, measurement conditions, and so on are not limited to the above.

The 50% cumulative particle size D_{E} (average particle size D_{E}) in volume-based particle size distribution of the resin particle is preferably 10 nm or more to 1,000 nm or less, further preferably 100 nm or more to 500 nm or less, and particularly preferably 100 nm or more to 400 nm or less. If the resin particle has an average particle size D_{E} of 100 nm or more to 400 nm or less, a porous film having holes can be formed. Consequently, the concealing property of an image can be enhanced by scattering that is caused by the difference between the refractive index of the binder constituted of titanium oxide and the resin and the refractive index of the hole.

The mass ratio of the content (mass %) of the resin particle to the content (mass %) of titanium oxide in the ink is preferably 0.3 times or more to 1.5 times or less and further preferably 0.3 times or more to 1.0 time or less. The volume ratio of the content (vol %) of the resin particle to the content (vol %) of titanium oxide in the ink is preferably 1.3 times or more to 5.0 times or less and further preferably 2.0 times or more to 4.0 times or less. A porous film having holes can be formed by adjusting the mass ratio or volume ratio to the above ranges. Consequently, the concealing property of an image can be enhanced by scattering that is caused by the difference between the refractive index of the binder constituted of the titanium oxide and the resin and the refractive index of the hole. In calculating the volume ratio, the volume-based content (volume %) can be simply obtained by dividing the mass-based content (mass %) by the density (specific gravity) of the resin particle or titanium oxide particle.

The resin forming the resin particle preferably has an anionic group. Since the anionic group of the resin reacts with the reactant, the resin particle also forms aggregate by using an ink containing the resin particle made of a resin having an anionic group. Consequently, the precipitation speed of the aggregate can be further increased.

Examples of the resin that forms a resin particle include a vinyl chloride-based resin, a styrene-based resin, a urethane-based resin, an acrylic resin and a polyester-based resin. In particular, from the viewpoint of the ejection property from a recording head, an acrylic resin, a polyester-based resin and a urethane-based resin are preferable. If a resin particle formed from a resin other than the above resins is used, the ejection of an ink may become slightly unstable, and as a result, film thickness unevenness may tend to occur.

In particular, the resin that forms the resin particle is preferably an acrylic resin. The acrylic resin preferably includes a hydrophilic unit and a hydrophobic unit as constitution units. In particular, a resin including a hydrophilic unit derived from (meth)acrylic acid and a hydrophobic unit derived from at least one of a monomer having an aromatic ring and a (meth)acrylic acid ester-based monomer is preferable. In particular, a resin including a hydrophilic unit derived from (meth)acrylic acid and a hydrophobic unit derived from at least one of styrene and α-methylstyrene monomers is preferable.

The hydrophilic unit is a unit having a hydrophilic group such as an anionic group. The hydrophilic unit can be formed by, for example, polymerizing a hydrophilic monomer including a hydrophilic group. Examples of the hydrophilic monomer including a hydrophilic group include an acidic monomer including a carboxylic acid group such as (meth)acrylic acid, itaconic acid, maleic acid and fumaric acid and an anionic monomer such as anhydrides and salts of these acidic monomers. Examples of the cation constituting a salt of the acidic monomer include ions of lithium, sodium, potassium, ammonium, organic ammonium and so on. The hydrophobic unit is a unit not including a hydrophilic group such as an anionic group. The hydrophobic unit can be formed by, for example, polymerizing a hydrophobic monomer not having a hydrophilic group such as an anionic group. Examples of the hydrophobic monomer include a monomer having an aromatic ring, such as styrene, α-methylstyrene, benzyl (meth)acrylate and phenoxyethyl (meth)acrylate; and a (meth)acrylic acid ester-based monomer, such as methyl (meth)acrylate, butyl (meth)acrylate and 2-ethylhexyl (meth)acrylate.

The glass transition temperature (Tg) of the resin particle is preferably −20° C. or more to 120° C. or less and further preferably 40° C. or more to 100° C. or less. The glass transition temperature of a resin particle can be measured using a thermal analysis apparatus such as a differential scanning calorimeter (DSC).

The resin that forms a resin particle may be a resin not having crystallinity or may be a resin having crystallinity. Whether a resin that forms a resin particle is a crystalline resin or not can be judged by measuring the degree of crystallinity of the resin using a differential scanning calorimeter. When a melting peak is not observed by observation with a differential scanning calorimeter, the resin is judged to be an amorphous resin. In contrast, when a melting peak is observed, the resin can be judged to be a crystalline resin. When the resin is a crystalline resin, the fusion heat is determined from the peak area, and the degree of crystallinity can be calculated from the ratio of the determined fusion heat and the fusion heat of a perfect crystal with a degree of crystallinity of 100% calculated by theoretical calculation.

The acid value of the resin forming the resin particle is preferably 5 mg KOH/g or more to 100 mg KOH/g or less. The weight-average molecular weight of the resin that forms the resin particle is preferably 1,000 or more to 3,000,000 or less and further preferably 100,000 or more to 3,000,000 or less. The resin particle does not necessarily contain a coloring material.

### Water-Soluble Resin

The ink contains a water-soluble resin including a unit having an acidic group. The proportion (mol %) of the unit having an acidic group in this water-soluble resin is 60.0 mol % or more, and the unit having an acidic group includes a unit having a plurality of carboxylic acid groups. Examples of the form of the resin include a block copolymer, a random copolymer, a graft copolymer and a combination thereof.

The water-soluble resin includes a unit having an acidic group, and this unit having an acidic group includes a unit having a plurality of carboxylic acid groups. The crosslink density between pigment particles is increased by using a water-soluble resin including a unit having a plurality of carboxylic acid groups, thereby the density of aggregate is increased, and occurrence of film thickness unevenness in an image can be suppressed. Examples of the monomer that becomes a unit having an acidic group by polymerization include a monomer having one acidic group, such as (meth)acrylic acid, crotonic acid and vinyl sulfonic acid; a monomer having a plurality of acidic groups, such as maleic acid, fumaric acid, itaconic acid, 2-sulfo(meth)acrylic acid and 3-sulfo(meth)acrylic acid; and anhydrides and salts of these monomers having an acidic group. Examples of the cation that constitutes a salt include ions of lithium, sodium, potassium, ammonium, organic ammonium and so on.

The water-soluble resin may be a copolymer further including a unit (optional unit) derived from a monomer other than the unit having an acidic group, in addition to the unit having an acidic group. Examples of the optional monomer that becomes another unit by polymerization include a monomer having an aromatic ring, such as styrene, α-methylstyrene, benzyl (meth)acrylate and phenoxyethyl (meth)acrylate; and (meth)acrylic acid ester-based monomer, such as methyl (meth)acrylate, butyl (meth)acrylate and 2-ethylhexyl (meth)acrylate.

The proportion (mol %) of the unit having an acidic group in the water-soluble resin is 60.0 mol % or more and preferably 70.0 mol % or more. If the proportion of the unit having an acidic group is less than 60.0 mol %, the crosslink density of aggregate cannot be increased. As a result, the precipitation speed of the particle cannot be increased, and the occurrence of film thickness unevenness cannot be suppressed. The proportion (mol %) of the unit having an acidic group in the water-soluble resin may be 100.0 mol %. The proportion (mol %) of the unit having an acidic group in the water-soluble resin can be calculated from the number of moles of the carboxylic acid groups calculated from the acid value of the water-soluble resin and the ratio of the constitution unit of the resin analyzed by NMR. The acid value of the water-soluble resin can be measured by colloid titration utilizing an electric potential difference.

The unit having a plurality of carboxylic acid groups preferably includes a unit derived from a dicarboxylic acid compound. On this occasion, the proportion (mol %) of the unit derived from the dicarboxylic acid compound in the unit having a plurality of carboxylic acid groups is preferably 7.5 mol % or more. If the proportion of the unit derived from the dicarboxylic acid compound is 7.5 mol % or more, the crosslink density between pigment particles is increased, thereby the density of aggregate is increased, and occurrence of film thickness unevenness in an image can be more effectively suppressed.

The dicarboxylic acid compound is preferably maleic acid. Since maleic acid has a molecular structure in which carboxylic acid groups are bonded to adjacent carbon atoms, respectively, the water-soluble resin including a unit derived from maleic acid tends to have an increased carboxylic acid group density. The acid dissociation constants (pKa) of maleic acid at 25° C. are pKa 1=1.94 and pKa 2=6.22. Within a pH range of about 7.0 to 9.0 which is a common pH of aqueous inks for ink jet recording, a part of the carboxylic acid groups included in the unit derived from maleic acid is dissociated and becomes a carboxylate ion. When the ink in such a state and a reaction liquid containing a polyvalent metal salt are brought into contact with each other, since the densities of the carboxylic acid group and the carboxylate ion are high, the crosslink density between pigment particles and the density of aggregate are increased, and the occurrence of film thickness unevenness in an image can be more effectively suppressed.

The acid value of the water-soluble resin is preferably 100 mg KOH/g or more and further preferably 1,000 mg KOH/g or less. If the acid value of the water-soluble resin is less than 100 mg KOH/g, the number of the acidic groups is small, and the reactivity when comes into contact with the reaction liquid may be weak. As a result, the aggregation property decreases, aggregate involving the pigment particles is not sufficiently formed, the precipitation speed is hardly increased, and the effect of suppressing film thickness unevenness may be slightly decreased. In contrast, if the acid value of the water-soluble resin is more than 1,000 mg KOH/g, the hydrophilicity is too high, and the water-soluble resin may be difficult to approach the pigment particles when aggregates. As a result, the aggregation property decreases, aggregate involving the pigment particles is not sufficiently formed, the precipitation speed is hardly increased, and the effect of suppressing film thickness unevenness may be slightly decreased. The acid value of the water-soluble resin can be measured by colloid titration utilizing an electric potential difference. When the structure of the water-soluble resin is clear, the acid value can be calculated can be calculated by determining the number of moles of the acidic group from the number of moles of each unit included in 1 g of the resin and assuming the number of moles of the acidic group to be equal to the number of moles of potassium hydroxide (molecular weight: 56.1) required to neutralize the acidic group.

The weight-average molecular weight of the water-soluble resin is preferably 1,000 or more to 30,000 or less and further preferably 5,000 or more to 20,000 or less. The weight-average molecular weight (Mw) is a value in terms of polystyrene measured by gel permeation chromatography (GPC).

The mass ratio of the content (mass %) of the water-soluble resin to the content (mass %) of titanium oxide in the ink is preferably 0.03 times or more to 0.20 times or less and further preferably 0.05 times or more to 0.10 times or less. When the mass ratio is less than 0.03 times, the number of the acidic groups in the water-soluble resin is small, and the crosslink density between the pigment particles may not be sufficiently increased. As a result, aggregate involving the pigment particles is not sufficiently formed, the precipitation speed is hardly increased, and the effect of suppressing film thickness unevenness may be slightly decreased. In contrast, if the mass ratio is more than 0.20 times, the amount of the water-soluble resin present in the ink in a free state tends to increase. As a result, aggregation of the pigment is prevented by the steric hindrance of the water-soluble resin, aggregate involving the pigment particles is not sufficiently formed, the precipitation speed is hardly increased, and the effect of suppressing film thickness unevenness may be slightly decreased.

Titanium oxide is preferably dispersed in the ink by the above-described water-soluble resin. That is, the water-soluble resin is preferably a resin dispersant for dispersing the titanium oxide. Compared to titanium oxide dispersed without using the above-described water-soluble resin, titanium oxide dispersed by the above-described water-soluble resin promptly aggregates when comes into contact with the reaction liquid, and the crosslink density between the pigment particles and the density of aggregate tend to be increased. Consequently, occurrence of film thickness unevenness in an image can be more effectively suppressed.

### Aqueous Medium

The ink is an aqueous ink at least containing water as an aqueous medium. The ink can contain water or an aqueous medium that is a mixture solvent of water and a water-soluble organic solvent. As the water, deionized water or ion exchanged water is preferably used. The content (mass %) of water in the ink is preferably 50.0 mass % or more to 95.0 mass % or less based on the total mass of the ink. The content (mass %) of the water-soluble organic solvent in the ink is preferably 3.0 mass % or more to 50.0 mass % or less based on the total mass of the ink. As the water-soluble organic solvent, any solvent that can be used in inks for ink jet recording, such as alcohols, (poly)alkylene glycols, glycol ethers, nitrogen-containing compounds and sulfur-containing compounds, can be used.

### Other Components

The ink may further contain a water-soluble organic compound that is a solid at 25° C., such as urea and its derivative, trimethylolpropane and trimethylolethane. The content (mass %) of the water-soluble organic compound in the ink is preferably 0.1 mass % or more to 10.0 mass % or less based on the total mass of the ink. The ink may contain various additional components other than the above components, as needed. Examples of the additional component include various additives, such as a surfactant, a defoaming agent, a pH adjuster, a viscosity adjuster, a corrosion inhibitor, a preservative, an antifungal agent, an antioxidant and a reducing inhibitor. However, the ink preferably does not contain a reactant that is contained in the reaction liquid.

### Physical Properties of Ink

The ink is an aqueous ink that is applied to an ink jet system. Accordingly, from the viewpoint of reliability, it is preferable to appropriately control the physical property values. Specifically, the surface tension of the ink at 25° C. is preferably 20 mN/m or more to 60 mN/m or less. The viscosity of the ink at 25° C. is preferably 1.0 mPa·s or more to 10.0 mPa·s or less. The pH of the ink at 25° C. is preferably 7.0 or more to 9.5 or less and further preferably 8.0 or more to 9.5 or less.

### Reaction Liquid

The reaction liquid reacts with the ink when becomes into contact with the ink and allows the component in the ink to aggregate, and contains a reactant. The reactant includes a polyvalent metal salt. The component constituting the reactant and so on will be described in detail below.

### Reactant

The reactant is a component that aggregates components (components including acidic groups, such as the water-soluble resin and the resin particle) in the ink. The reactant includes a polyvalent metal salt.

The polyvalent metal salt is a compound constituted of a divalent or higher metal ion (polyvalent metal ion) and an anion. The polyvalent metal salt is dissociated in the reaction liquid and becomes a polyvalent metal ion to aggregate the components having acidic groups in the ink. Examples of the polyvalent metal ion include divalent metal ions such as Ca²⁺, Cu²⁺, Ni²⁺, Mg²⁺, Sr²⁺, Ba²⁺ and Zn²⁺; and trivalent metal ions such as Fe³⁺, Cr³⁺, Y³⁺ and Al³⁺. Examples of the anion constituting the polyvalent metal salt include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; and organic anions such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. In order to add a polyvalent metal ion to the reaction liquid, a water-soluble polyvalent metal salt (which may be a hydrate) constituted of a polyvalent metal ion and an anion can be used.

Examples of the polyvalent metal salt include calcium carbonate, such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, aluminum acetate, aluminum sulfate, calcium methanesulfonate, calcium lactate, magnesium lactate, calcium propionate, calcium acetate, calcium pantothenate and calcium gluconate. Among them, magnesium sulfate can easily adjust the reaction rate and is therefore preferable.

The content (mass %) of the polyvalent metal salt in the reaction liquid is preferably 1.0 mass % or more to 20.0 mass % or less based on the total mass of the reaction liquid. In the present specification, the “content (mass %) of the polyvalent metal salt” in the reaction liquid when the polyvalent metal salt is a hydrate means the “content (mass %) of the anhydride of the polyvalent metal salt” excluding water as a hydrate. The concentration (mol/L) of the metal ion derived from the polyvalent metal salt in the reaction liquid is preferably 0.4 mol/L or more and further preferably 0.4 mol/L or more to 1.5 mol/L or less. If the concentration of the metal ion is less than 0.4 mol/L, it is necessary to apply a large amount of the reaction liquid in order to aggregate the component in the ink. Accordingly, the amount of the liquid component is increased to take a long period of time for precipitating the aggregate, and the effect of suppressing film thickness unevenness may be decreased. The concentration of metal ion in the reaction liquid can be calculated from the formula weight of the polyvalent metal salt.

As the reactant, an organic acid, a cationic resin, or the like can be used together with the polyvalent metal salt. In particular, the size of the aggregate can be further increased by using a cationic resin as a reactant. Accordingly, it is preferable that the reactant further includes a cationic resin. That is, the effect of suppressing film thickness unevenness can be more enhanced by using a cationic resin as a reactant together with the polyvalent metal salt.

The cationic resin has a cationic portion in the structure of the resin and aggregates the pigment and so on that are dispersed by the action of the anionic group in the ink. Examples of the cationic resin include resins having primary to tertiary amine structures and resins having a quaternary ammonium salt, specifically, resins having the structure of vinylamine, allylamine, vinylimidazole, vinylpyridine, dimethylaminoethyl methacrylate, ethyleneimine, guanidine, diallyldimethylammonium chloride and alkylamine-epichlorohydrin condensate. In order to enhance the solubility in the reaction liquid, a combination of a cationic resin and an acidic compound may be used, or a cationic resin may be subjected to quaternarization. The content (mass %) of the cationic resin in the reaction liquid is preferably 0.03 mass % or more to 10.0 mass % or less based on the total mass of the reaction liquid.

The reaction liquid containing an organic acid has buffer capacity in an acidic region (a pH of less than 7.0, preferably a pH of 2.0 to 5.0) and thereby efficiently converts the anionic group of a component present in the ink into the acid form and aggregates it. Examples of the organic acid include monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumaric acid; and salts thereof; dicarboxylic acids, such as oxalic acid, malonic acid, succinic acid, glutaric acid, adipic acid, maleic acid, fumaric acid, itaconic acid, sebacic acid, phthalic acid, malic acid and tartaric acid; and salts and hydrogen salts thereof; tricarboxylic acids, such as citric acid and trimellitic acid; and salts and hydrogen salts thereof; and tetracarboxylic acids, such as pyromellitic acid; and salts and hydrogen salts thereof. The content (mass %) of the organic acid in the reaction liquid is preferably 1.0 mass % or more to 50.0 mass % or less based on the total mass of the reaction liquid.

### Aqueous Medium

The reaction liquid is a reaction liquid at least containing water as an aqueous medium. Examples of the aqueous medium that is used in the reaction liquid include the same aqueous media mentioned above as those that can be contained in the ink.

### Other Component

The reaction liquid may contain various optional components as needed. Examples of the optional component include the same optional components mentioned above as those that can be contained in the ink.

### Physical Property of Reaction Liquid

The reaction liquid is applied to an ink jet system. Accordingly, from the viewpoint of reliability, it is preferable to appropriately control the physical property values. Specifically, the surface tension of the reaction liquid at 25° C. is preferably 20 mN/m or more to 60 mN/m or less. The viscosity of the reaction liquid at 25° C. is preferably 1.0 mPa·s or more to 10.0 mPa·s or less. The pH of the reaction liquid at 25° C. is preferably 5.0 or more to 9.5 or less and further preferably 6.0 or more to 9.0 or less.

### Ink Jet Recording Method, Ink Jet Recording Apparatus

The ink jet recording method of the present disclosure includes a step of ejecting and applying an ink and a reaction liquid from the recording head of an ink jet system to a recording medium. The ink and the reaction liquid include the aqueous ink and the reaction liquid included in the above-described ink set. More specifically, the ink jet recording method of the present disclosure preferably includes a reaction liquid application step of applying a reaction liquid to a recording medium and an ink application step of applying an aqueous ink so as to overlap at least a part of the region of the recording medium to which the reaction liquid is applied. In particular, it is preferable to perform the reaction liquid application step before the ink application step or perform the ink application step and the reaction liquid application step in parallel. However, the image is not required to be cured by irradiation with active energy rays or the like.

The ink jet recording apparatus of the present disclosure is an apparatus that includes an ink, a reaction liquid, and a recording head of an ink jet system that ejects the ink and the reaction liquid and is suitably used in the above-described ink jet recording method. The ink and the reaction liquid include the aqueous ink and the reaction liquid that are included in the above-described ink set. The ink jet recording method and the ink jet recording apparatus (hereinafter, also referred simply to as “recording method” and “recording apparatus”) of the present disclosure will be described in detail below.

### Ink Jet Recording Apparatus

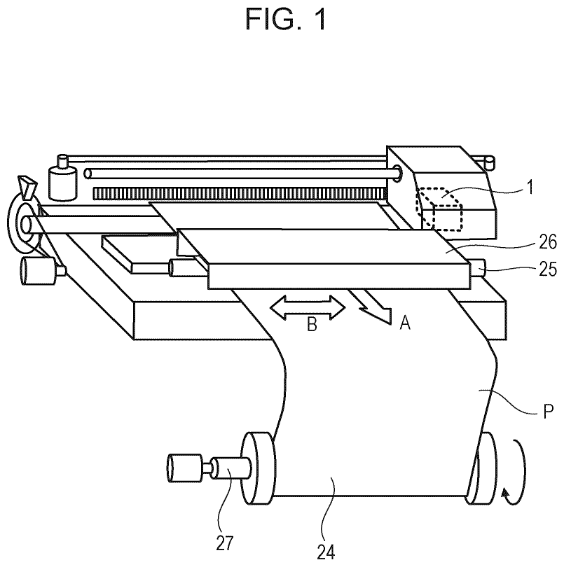

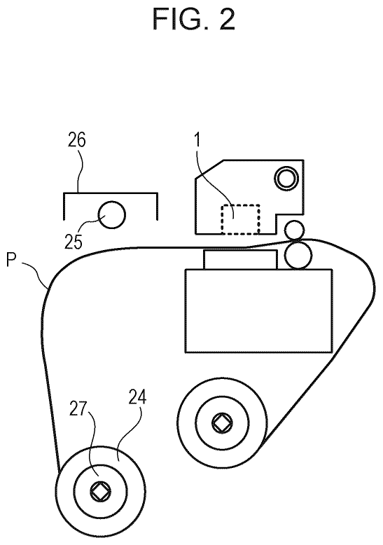

FIG. 1 is a perspective view schematically illustrating an embodiment of the ink jet recording apparatus of the present disclosure. FIG. 2 is a side view schematically illustrating an embodiment of the ink jet recording apparatus of the present disclosure. As is shown in FIGS. 1 and 2, the recording apparatus of the present embodiment includes a recording head 1 of an ink jet system that ejects liquids (ink and reaction liquid). Examples of the recording head include a recording head that ejects an ink and a reaction liquid by the action of mechanical energy and a recording head that ejects an ink and a reaction liquid by the action of heat energy. In particular, preferred is a recording heat that ejects an ink and a reaction liquid by the action of heat energy. The recording head that ejects an ink and a reaction liquid by the action of heat energy is a recording head of a thermal system in which that ejects an ink and a reaction liquid from an ejection port by applying heat energy to the ink and the reaction liquid through application of an electric pulse to an electrothermal conversion element. The recording head preferably has a mechanism (temperature adjustment mechanism) for heating the liquid therein to a predetermined temperature. When a temperature adjustment mechanism is adopted, the temperature of liquids (ink and reaction liquid) that are ejected from the recording head is preferably 35° C. or more to 70° C. or less.

An ink is applied to a unit area of a recording medium preferably by multipass recording that performs relative scanning of the recording head and the recording medium multiple times. When an image is recorded using a combination of a white ink and a color ink, the white ink and the color ink are preferably applied to a unit area by different relative scanning protocols. Consequently, the time it takes for ink droplets to come into contact with each other increases, and mixing is easily suppressed. The unit area can be set as an arbitrary region such as 1 pixel or 1 band.

The mass ratio of the application amount of the reaction liquid to the application amount of the ink per unit area of the recording medium is preferably 0.10 times or more to 0.80 times or less and further preferably 0.20 times or more to 0.50 times or less. High-density aggregate is formed by applying the ink and the reaction liquid to a recording medium at the above mass ratio, and the precipitation speed can be increased. Consequently, film thickness unevenness can be more effectively suppressed.

### Drying Step

The recording method of the present disclosure preferably further includes a drying step of blowing air to the recording medium applied with an ink and a reaction liquid to dry at least a part of the liquid component on the recording medium. As a result of carrying out such a drying step, a high-quality image can be recorded even on a non-absorbent recording medium. The liquid component on the recording medium gradually dries even if the drying step is not carried out. However, drying of the liquid component is accelerated by carrying out the drying step, and an image efficiently filled with the pigment can be recorded. The drying step may be carried out in multiple times. The drying step may be carried out simultaneously with a heating step or may be carried out using the same heating means as that in the heating step described below.

The blowing air speed for drying an image is preferably 1 m/s or more to 100 m/s or less. When the air blowing does not also serve as heating, the temperature of the air is not required to be adjusted, and air of room temperature may be blown. When the air blowing also serves as heating,
the temperature of the air may be a temperature higher than room temperature and is preferably 30° C. or more to 200° C. or less, further preferably 50° C. or more to 150° C. or less, and particularly preferably 80° C. or more to 120° C. or less. The temperature of the air can be measured by, for example, using a K-type thermocouple thermometer. Examples of the thermometer include “AD-5605H” (trade name, manufactured by A&D Co., Ltd.). As needed, although an air flow may be applied to the rear surface of a recording medium, an air flow is preferably applied to the front surface (recording surface) of a recording medium. The distance from the blower to the recording medium is preferably 5 mm or more to 50 mm or less.

### Heating Step

The recording method of the present disclosure preferably includes a heating step of heating (heat treatment) the recording medium applied with an ink and a reaction liquid. In the heating step, the recording medium applied with an ink and a reaction liquid is heated. Consequently, fusion of the resin particle in the ink is accelerated to generate a resin film, and an image with improved abrasion resistance can be recorded.

When the requirements (i) to (iii) shown below are satisfied, the recording medium applied with an ink and a reaction liquid is preferably heated to a temperature equal to or higher than the glass transition temperature Tg (° C.) or melting point T_{M} (° C.) of the resin particle. That is, the heating temperature T_{H} (° C.) can be appropriately set depending on the glass transition temperature Tg (° C.) or melting point T_{M} (° C.) of the resin particle. When the resin that forms a resin particle is a crystalline resin, since the resin particle has a glass transition temperature Tg (° C.) and a melting point T_{M} (° C.), the recording medium may be heated to the melting point T_{M} (° C.) or more:
(i) the average primary particle size D_{P0} (nm) of the titanium oxide is 150 nm or less;
(ii) the average particle size D_{E} (nm) of the resin particle is 100 nm or more to 400 nm or less; and
(iii) the volume ratio of the content (vol %) of the resin particle to the content (vol %) of the titanium oxide in the ink is 1.3 times or more to 5.0 times or less.

Air is blown to the recording medium applied with an ink and a reaction liquid to evaporate and dry at least a part of the liquid component on the recording medium, and thereby gaps are formed between aggregated pigment particles. Subsequently, heating to a temperature equal to or higher than the glass transition temperature Tg (° C.) or melting point T_{M} (° C.) of the resin particle is performed to fuse the resin particle, and the fused resin permeates into gaps by the capillary force. At the same time, holes are formed at the positions where the resin particles were present. The fused resin permeates into the gaps, thereby a binder that is a mixture of the pigment and the fused resin is formed, and an image containing holes therein can be fixed to the recording medium. Since the refractive index of the hole is relatively lower than that of the binder, incident visible light is scattered due to the difference between the refractive indexes of the binder and the hole. Consequently, an image with a further improved concealing property can be recorded.

The upper limit of the heating temperature T_{H} (° C.) is not particularly limited, but is preferably 200° C. or less from the viewpoint of heat-resistant temperature of the recording medium. The heating temperature T_{H} (° C.) means the highest reaching temperature of the recording medium surface during the heating step. The “heating temperature T_{H} (° C.)” may be replaced with the “setting temperature (° C.) of the heating means”. The heating temperature T_{H} (° C.) can be measured using, for example, a contact thermometer that brings a thermocouple or the like into contact with the surface of the recording medium or a non-contact infrared thermometer. In Examples described below, the surface temperature of a recording medium was measured using a non-contact infrared thermometer, digital radiation temperature sensor (trade name “FT-H20”, manufactured by Keyence Corporation, not shown) from a position 10 cm vertically above the surface of the recording medium. The heating temperature T_{H} (° C.) is preferably 30° C. or more, further preferably 50° C. or more and particularly preferably 80° C. or more.

Examples of the means for heating a recording medium include known heating means such as a heater, an air-blowing means using air blowing such as a dryer, and a heating means such as a combination thereof. Examples of the heating means include the above-mentioned heating means, air blowing means, and a combination thereof. Examples of the method of heat treatment include a method of applying heat from the opposite side (rear surface) of the recording surface (ink application surface) of a recording medium with a heater, a method of applying warm air or hot air to the recording surface of a recording medium, and a method of heating from the recording surface or rear surface using an infrared heater. Alternatively, a combination of two or more thereof may be used. Furthermore, heating may be performed by bringing a heated member into contact with the recording surface or rear surface of a recording medium. The heating step may be carried out for any period of time that is sufficient for fusing resin particles. For example, the temperature of the air when a recording medium is heated by an air-blowing means can be 80° C. or more to 120° C. or less.

In the recording apparatus shown in FIGS. 1 and 2, the main scanning direction B in which the recording head 1 reciprocally scans and the sub-scanning direction A which is the conveyance direction of the recording medium P are orthogonal to each other. A heater 25 supported by a frame (not shown) is disposed at a position downstream from the position where the recording head 1 reciprocally scans in the sub-scanning direction A. The recording medium P applied with a reaction liquid and an ink can be heated from the rear surface by the heater 25. Examples of the heater 25 include a sheath heater and a halogen heater. The heater 25 is covered with a heater cover 26. The heater cover 26 is a member for efficiently irradiating the recording medium P with heat generated by the heater 25. Furthermore, the heater cover 26 is also a member for protecting the heater 25. The recording medium P applied with the ink ejected from the recording head 1 is wound by the winding spool 27 to form a roll-shaped wound medium 24.

### Recording Medium

The type of the recording medium for recording an image is not particularly limited, and any recording medium may be used. In particular, since a white ink that can record an image, such as a white image, is used, a recording medium other than a so-called “white”, such as a transparent film, a translucent film and colored paper, is preferably used.

According to the ink jet recording method of the present disclosure, an image with suppressed film thickness unevenness can be recorded even on a low to non-absorbent recording medium. The “low to non-absorbent recording medium” in the present specification means a recording medium of which the water absorption amount from the start of contact to 30 msec^{1/2} is 10 mL/m² or less in the Bristow method. The water absorption may be 0 mL/m². The Bristow method is a widely used method for measuring the amount of liquid absorbed in a short time and is employed also by Japan Technical Association of the Pulp and Paper Industry (JAPAN TAPPI). The details of the test method are described in Standard No. 51 “Paper and Paperboard—Liquid Absorbency Test Method—Bristow Method” in “JAPAN TAPPI Paper and Pulp Test Methods 2000 Edition”. A recording medium provided with an ink-receiving layer for ink jet recording (such as glossy paper and mat paper) and plain paper not having a coat layer are “absorbent recording media” having a water absorbency of greater than 10 mL/m².

Examples of the low absorbent recording medium include a recording medium not having an ink-receiving layer and a recording medium with a thin ink-receiving layer, specifically, printing paper such as art paper, fine coated paper, medium coated paper, fine lightweight coated paper, medium lightweight coated paper, lightly coated paper and cast coated paper. Examples of the non-absorbent recording medium include a recording medium not having an ink-receiving layer and a recording medium having a thin ink-receiving layer, specifically, a plastic film and a substrate, such as paper, coated with a plastic. Examples of the plastic include polyvinyl chloride, polyethylene terephthalate, polycarbonate, polystyrene, polyurethane, polyethylene and polypropylene. Other examples of the non-absorbent recording medium include glass, a metal and ceramic. In particular, a plastic film and a substrate, such as paper, coated with a plastic are preferable. The “recording medium” in the present specification means an object on which an image as a recorded matter is recorded, not as a transfer body.

### Examples

The present disclosure will be described in more detail with reference to Examples and Comparative Examples below, but the present disclosure is not limited in any way by the following Examples, as long as the gist of the disclosure is not exceeded. The amounts of components expressed as “parts” and “%” are by mass unless otherwise specified. A “dispersion liquid of titanium oxide” is also mentioned as “pigment dispersion liquid” hereinafter.

### Measurement of Physical Property Value

### Average Primary Particle Size and Average Particle Size

The average primary particle size (D_{P0}) of titanium oxide was measured by the following method. Firstly, a sample was photographed using a scanning electron microscope (trade name “5-4700”, manufactured by Hitachi High-Tech Corporation) at a magnification of 100,000. Secondly, the diameters of circles circumscribing 100 primary particles of a metal oxide were measured, and the average thereof was defined as an “average primary particle size (D_{P0})”. The average particle size (D_{P}) of titanium oxide was measured using a particle size measurement apparatus (trade name “UPA-EX150”, manufactured by Nikkiso Co., Ltd.) by a dynamic light scattering method. The average particle size (D_{E}) of the resin particle (50% cumulative particle size in volume-based particle size distribution) was also measured using the particle size measurement apparatus.

### Glass Transition Temperature and Melting Point of Resin Particle

The glass transition temperature Tg of the resin particle was measured using a differential scanning calorimeter (DSC). Specifically, 2 mg of a resin particle obtained by drying and solidifying a liquid containing a resin particle at 60° C. was placed in an aluminum container and sealed to prepare a sample for measurement. The prepared sample was subjected to thermal analysis using a differential scanning calorimeter (trade name “DSC-2500”, manufactured by TA instruments) according to the temperature program shown below. The glass transition temperature of a resin particle in the present specification is defined as follows. That is, in the temperature rise curve (horizontal axis: temperature, vertical axis: heat quantity) of the temperature program (3) below, the temperature at an intersection point of a straight line passing through two points on the curve on the low-temperature side and extending to the high-temperature side and the tangent line drawn at the point where the gradient of the stepwise change on the curve is the greatest is determined. The thus-determined temperature was defined as the “glass transition temperature Tg of the resin particle”.

### Temperature Program:

(1) temperature rise from 20° C. to 200° C. at a rate of 10° C./min;
(2) temperature drop from 200° C. to −50° C. at a rate of 5° C./min; and
(3) temperature rise from −50° C. to 200° C. at a rate of 10° C./min.

### Specific Gravity

The specific gravities of titanium oxide and the resin particle were measured by a Gay-Lussac specific gravity bottle (pycnometer) method in accordance with JIS Z 8807.

### Preparation of Titanium Oxide

Titanium oxide 1 to 5 of the types shown in Table 1 were prepared. The specific gravities of titanium oxide 1 to 5 were all 4.2, and the refractive indexes were all within a range of 2.5 or more to 2.8 or less.

TABLE 1
Type of titanium oxide

| Titanium | D_{P0} | Surface | |
|---|---|---|---|
| oxide | (nm) | treatment | Trade name |
| 1 | 15 | Silica | Trade name “MT-100WP”, manufactured |
| | | | by Tayca Corp. |
| 2 | 25 | Alumina, | Trade name “MT-500SA”, manufactured |
| | | Silica | by Tayca Corp. |
| 3 | 15 | Silica | Trade name “STR-100W”, manufactured |
| | | | by Sakai Chemical Industry Co., Ltd. |
| 4 | 80 | — | Trade name “MT-700B”, manufactured |
| | | | by Tayca Corp. |
| 5 | 250 | Alumina, | Trade name “TIPAQUE CR-80”, |
| | | Silica | manufactured by Ishihara Sangyo Kaisha, |
| | | | Ltd. |

### Preparation of Water-Soluble Resin

The following water-soluble resins 1 to 15 were prepared. The characteristics of the water-soluble resins are shown in Table 2. Each water-soluble resin was converted to the sodium salt form as needed and was then used for preparing an ink.

### Water-Soluble Resins 1, 5 and 9 to 15

Commercially available resin aqueous solutions shown in Tale 2 were used as the aqueous solutions of water-soluble resins 1, 5, and 9 to 15.

### Water-Soluble Resin 2

Acrylic acid (61.8 parts) and toluene (20.0 parts) were placed in a flask, and after nitrogen substitution, maleic acid (5.2 parts) and an initiator (di-tert-butyl peroxide, 0.36 parts) were added thereto while heating and stirring at 90° C. Toluene was evaporated while reacting at 160° C. for 6 hours. After completion of the reaction, the content was cooled and solidified to obtain a maleic acid-acrylic acid copolymer. Sodium hydroxide was added thereto, and the resulting mixture was dissolved in ion exchanged water to obtain an aqueous solution of a water-soluble resin 2 with a resin content of 40.0%.

### Water-Soluble Resin 3

An aqueous solution of a water-soluble resin 3 with a resin content of 40.0% was obtained as in the above-described water-soluble resin 2 except that acrylic acid (59.3 parts) and maleic acid (7.7 parts) were used.

### Water-Soluble Resin 4

An aqueous solution of a water-soluble resin 4 with a resin content of 40.0% was obtained as in the above-described water-soluble resin 2 except that acrylic acid (47.8 parts) and maleic acid (19.2 parts) were used.

### Water-Soluble Resin 6

Pure water (85 parts) was placed in a 2.5-L stainless steel separable flask equipped with a thermometer, a stirrer and a reflux condenser and was heated to a boiling point while stirring to a reflux condition. Itaconic acid (221.2 parts), pure water (73.7 parts) and a 48% sodium hydroxide aqueous solution (255.0 parts) were mixed to prepare a 40% sodium itaconate aqueous solution. After stirring, while maintaining the reflux condition at the boiling point, an 80% acrylic acid aqueous solution (262.5 parts), a 40% sodium itaconate aqueous solution (49.7 parts), a 5% hydrogen peroxide solution (34.0 parts) and a 13% sodium persulfate aqueous solution (31.4 parts) were dropwise added to the flask from separate dropping nozzles. After completion of the dropping, heating was performed for 50 minutes while maintaining the reflux condition at the boiling point to polymerize the monomer. An appropriate amount of ion exchanged water was added thereto to obtain an aqueous solution of a water-soluble resin 6 with a resin content of 40.0%.

### Water-Soluble Resin 7

An aqueous solution of a water-soluble resin 7 with a resin content of 40.0% was obtained as in the above-described water-soluble resin 6 except that an 80% acrylic acid aqueous solution (282.0 parts) and a 40% sodium itaconate aqueous solution (83.0 parts) were used.

### Water-Soluble Resin 8

An aqueous solution of a water-soluble resin 8 with a resin content of 40.0% was obtained as in the above-described water-soluble resin 6 except that an 80% acrylic acid aqueous solution (153.0 parts) and a 40% sodium itaconate aqueous solution (553.0 parts) were used.

TABLE 2
Characteristics of water-soluble resin

| | | Proportion (mol %) of unit in resin | | | | |
|---|---|---|---|---|---|---|
| | | Unit | Unit derived | | | |
| Water- | | having | from | Unit derived | Content | |
| soluble | | acidic | dicarboxylic | from maleic | of resin | |
| resin | Type of resin | group | acid compound | acid | (%) | Note |
| 1 | Maleic acid-acrylic | 100.0 | 37.1 | 37.1 | 40.0 | Trade name “Aron A- |
| | acid copolymer | | | | | 6330”, manufactured |
| | | | | | | by Toagosei Co., Ltd. |
| 2 | Maleic acid-acrylic | 100.0 | 5.0 | 5.0 | 40.0 | — |
| | acid copolymer | | | | | |
| 3 | Maleic acid-acrylic | 100.0 | 7.5 | 7.5 | 40.0 | — |
| | acid copolymer | | | | | |
| 4 | Maleic acid-acrylic | 100.0 | 20.0 | 20.0 | 40.0 | — |
| | acid copolymer | | | | | |
| 5 | Maleic acid-acrylic | 100.0 | 50.0 | 50.0 | 37.0 | Trade name “Aqualic |
| | acid copolymer | | | | | TL-37”, |
| | | | | | | manufactured by |
| | | | | | | Nippon Shokubai |
| | | | | | | Co., Ltd. |
| 6 | Itaconic acid-acrylic | 100.0 | 5.0 | 0.0 | 40.0 | — |
| | acid copolymer | | | | | |
| 7 | Itaconic acid-acrylic | 100.0 | 7.5 | 0.0 | 40.0 | — |
| | acid copolymer | | | | | |
| 8 | Itaconic acid-acrylic | 100.0 | 50.0 | 0.0 | 40.0 | — |
| | acid copolymer | | | | | |
| 9 | Diisobutylene-maleic | 50.0 | 50.0 | 50.0 | 25.0 | Trade name “Demol |
| | acid copolymer | | | | | EP”, manufactured by |
| | | | | | | Kao Corp. |
| 10 | Polyether-modified | 2.3 | 2.3 | 2.3 | 40.0 | Trade name |
| | styrene-maleic | | | | | “DISPERBYK-190”, |
| | anhydride copolymer | | | | | manufactured by |
| | | | | | | BYK Chemie |
| 11 | Modified styrene- | 4.8 | 4.8 | 4.8 | 40.0 | Trade name |
| | maleic acid | | | | | “DISPERBYK- |
| | copolymer | | | | | 2010”, manufactured |
| | | | | | | by BYK Chemie |
| 12 | Modified styrene- | 2.3 | 2.3 | 2.3 | 40.0 | Trade name |
| | maleic anhydride | | | | | “DISPERBYK- |
| | copolymer | | | | | 2015”, manufactured |
| | | | | | | by BYK Chemie |
| 13 | Polycarboxylic acid | 100.0 | 0.0 | 0.0 | 43.0 | Trade name “SN- |
| | | | | | | Dispersant 5040”, |
| | | | | | | manufactured by San |
| | | | | | | Nopco Ltd. |
| 14 | Polyacrylic acid | 100.0 | 0.0 | 0.0 | 43.0 | Trade name “Aron A- |
| | | | | | | 210”, manufactured |
| | | | | | | by Toagosei Co., Ltd. |
| 15 | Polyacrylic acid | 100.0 | 0.0 | 0.0 | 43.0 | Trade name “Aron T- |
| | | | | | | 50”, manufactured by |
| | | | | | | Toagosei Co., Ltd. |

### Preparation of Pigment Dispersion Liquid

### Pigment Dispersion Liquids 1 to 20, 22 to 35 and 37 to 44

Titanium oxide and an aqueous solution of a water-soluble resin of the types and amounts shown in Table 3 were mixed with ion exchanged water such that the total of the component was 100.0%, followed by preliminary dispersion using a homogenizer. After mixing with 0.05-mm zirconia beads (100 parts), dispersion treatment was performed using a bead mill adjusted to a peripheral speed that gives a desired particle size for 5 hours. The zirconia beads were removed by filtration, an appropriate amount of ion exchanged water was added thereto as needed to obtain pigment dispersion liquids 1 to 20, 22 to 35 and 37 to 44. The content C_{P} (%) of titanium oxide in the pigment dispersion liquid, the content C_{S} (%) of the water-soluble resin, the value (times) of C_{S}/C_{P} and the average particle size D_{P} (nm) of titanium oxide are shown in Table 3.

### Pigment Dispersion Liquids 21 and 39

Titanium oxide (35.0 parts) of the type shown in Table 3, triethanolamine (1.75 parts), ion exchanged water (63.25 parts) and 0.05 mm zirconia beads (100 parts) were mixed and dispersed using a bead mill adjusted to a peripheral speed that gives a desired particle size for 5 hours. The zirconia beads were removed by filtration, an appropriate amount of ion exchanged water was added thereto as needed to obtain pigment dispersion liquids 21 and 39. The content C_{P} (%) of titanium oxide in the pigment dispersion liquid, the content C_{S} (%) of the water-soluble resin, the value (times) of C_{S}/C_{P} and the average particle size D_{P} (nm) of titanium oxide are shown in Table 3.

TABLE 3
Preparation conditions and characteristics of pigment dispersion liquid

| | Preparation condition | | | | | | | | |
|---|---|---|---|---|---|---|---|---|---|
| | | | Resin dispersant (Water-soluble | | | Characteristic | | | |
| | | | resin aqueous solution) | | | Content (%) | | | |
| | | | Type of | Content | | | Water- | | |
| Pigment | Titanium oxide | | water- | of water- | | Titanium | soluble | Value of | |
| dispersion | | Amount | soluble | soluble | Amount | oxide | resin | C_{S}/C_{P} | D_{P} |
| liquid | Type | (parts) | resin | resin (%) | (parts) | C_{P} (%) | C_{S} (%) | (times) | (nm) |
| 1 | 1 | 38.0 | 1 | 40.0 | 4.8 | 38.0 | 1.9 | 0.05 | 130 |
| 2 | 2 | 38.0 | 1 | 40.0 | 4.8 | 38.0 | 1.9 | 0.05 | 100 |
| 3 | 3 | 38.0 | 1 | 40.0 | 4.8 | 38.0 | 1.9 | 0.05 | 280 |
| 4 | 4 | 38.0 | 1 | 40.0 | 4.8 | 38.0 | 1.9 | 0.05 | 220 |
| 5 | 1 | 38.0 | 1 | 40.0 | 2.8 | 38.0 | 1.1 | 0.03 | 130 |
| 6 | 1 | 38.0 | 1 | 40.0 | 3.8 | 38.0 | 1.5 | 0.04 | 130 |
| 7 | 1 | 38.0 | 1 | 40.0 | 5.8 | 38.0 | 2.3 | 0.06 | 130 |
| 8 | 1 | 38.0 | 1 | 40.0 | 6.8 | 38.0 | 2.7 | 0.07 | 130 |
| 9 | 1 | 38.0 | 1 | 40.0 | 9.5 | 38.0 | 3.8 | 0.10 | 130 |
| 10 | 1 | 38.0 | 5 | 37.0 | 10.3 | 38.0 | 3.8 | 0.10 | 130 |
| 11 | 1 | 38.0 | 1 | 40.0 | 2.8 | 38.0 | 1.1 | 0.03 | 130 |
| 12 | 1 | 38.0 | 1 | 40.0 | 2.0 | 38.0 | 0.8 | 0.02 | 130 |
| 13 | 1 | 38.0 | 1 | 40.0 | 2.5 | 38.0 | 1.0 | 0.03 | 130 |
| 14 | 1 | 38.0 | 1 | 40.0 | 4.8 | 38.0 | 1.9 | 0.05 | 130 |
| 15 | 1 | 38.0 | 2 | 40.0 | 4.8 | 38.0 | 1.9 | 0.05 | 130 |
| 16 | 1 | 38.0 | 3 | 40.0 | 4.8 | 38.0 | 1.9 | 0.05 | 130 |
| 17 | 1 | 38.0 | 4 | 40.0 | 4.8 | 38.0 | 1.9 | 0.05 | 130 |
| 18 | 1 | 38.0 | 6 | 40.0 | 100.0 | 38.0 | 40.0 | 1.05 | 130 |
| 19 | 1 | 38.0 | 7 | 40.0 | 100.0 | 38.0 | 40.0 | 1.05 | 130 |
| 20 | 1 | 38.0 | 8 | 40.0 | 100.0 | 38.0 | 40.0 | 1.05 | 130 |
| 21 | 1 | 35.0 | — | — | — | 35.0 | 0.0 | 0.00 | 100 |
| 22 | 1 | 38.0 | 9 | 25.0 | 100.0 | 38.0 | 25.0 | 0.66 | 130 |
| 23 | 1 | 38.0 | 10 | 40.0 | 11.5 | 38.0 | 4.6 | 0.12 | 130 |
| 24 | 1 | 38.0 | 11 | 40.0 | 11.5 | 38.0 | 4.6 | 0.12 | 130 |
| 25 | 1 | 38.0 | 12 | 40.0 | 11.5 | 38.0 | 4.6 | 0.12 | 130 |
| 26 | 1 | 38.0 | 13 | 43.0 | 2.6 | 38.0 | 1.1 | 0.03 | 100 |
| 27 | 1 | 38.0 | 14 | 43.0 | 2.6 | 38.0 | 1.1 | 0.03 | 130 |
| 28 | 1 | 38.0 | 15 | 43.0 | 2.6 | 38.0 | 1.1 | 0.03 | 130 |
| 29 | 5 | 38.0 | 1 | 40.0 | 4.8 | 38.0 | 1.9 | 0.05 | 250 |
| 30 | 5 | 38.0 | 1 | 40.0 | 4.8 | 38.0 | 1.9 | 0.05 | 250 |
| 31 | 5 | 38.0 | 1 | 40.0 | 2.0 | 38.0 | 0.8 | 0.02 | 250 |
| 32 | 5 | 38.0 | 1 | 40.0 | 2.5 | 38.0 | 1.0 | 0.03 | 250 |
| 33 | 5 | 38.0 | 1 | 40.0 | 4.8 | 38.0 | 1.9 | 0.05 | 250 |
| 34 | 5 | 38.0 | 2 | 40.0 | 4.8 | 38.0 | 1.9 | 0.05 | 250 |
| 35 | 5 | 38.0 | 3 | 40.0 | 4.8 | 38.0 | 1.9 | 0.05 | 250 |
| 36 | 5 | 38.0 | 6 | 40.0 | 100.0 | 38.0 | 40.0 | 1.05 | 250 |
| 37 | 5 | 38.0 | 7 | 40.0 | 100.0 | 38.0 | 40.0 | 1.05 | 250 |
| 38 | 5 | 38.0 | 8 | 40.0 | 100.0 | 38.0 | 40.0 | 1.05 | 250 |
| 39 | 5 | 35.0 | — | — | — | 35.0 | 0.0 | 0.00 | 250 |
| 40 | 5 | 38.0 | 9 | 25.0 | 100.0 | 38.0 | 25.0 | 0.66 | 250 |
| 41 | 5 | 38.0 | 10 | 40.0 | 11.5 | 38.0 | 4.6 | 0.12 | 250 |
| 42 | 5 | 38.0 | 11 | 40.0 | 11.5 | 38.0 | 4.6 | 0.12 | 250 |
| 43 | 5 | 38.0 | 12 | 40.0 | 11.5 | 38.0 | 4.6 | 0.12 | 250 |
| 44 | 5 | 38.0 | 15 | 43.0 | 2.6 | 38.0 | 1.1 | 0.03 | 250 |

### Preparation of Resin Particle

The following resin particles 1 to 7 were prepared. The aqueous dispersion liquids of resin particles 1 to 3 were prepared by the method shown below. As the monomers, styrene (St), acrylonitrile (AN), 2-ethylhexyl acrylate (2EHA), methacrylic acid (MAA) and methyl methacrylate (MMA) were used. As the chain transfer agent, 2-ethylhexyl-3-mercaptopropionate (trade name “EHMP”, manufactured by SC Organic Chemical Co., Ltd.) was used. As the reactive surfactant, trade name “ADEKA REASOAP SR-10” (manufactured by ADEKA Corporation) was used. The specific gravities of the resin particles measured by the above-described method were all 1.0.

### Resin Particle 1

A reaction vessel equipped with a stirrer was set in a hot water tank. Water (1.178 parts) was placed in the reaction vessel, and the internal temperature was maintained at 70° C. St (97.0 parts) and a reactive surfactant (3.0 parts) were mixed to prepare a monomer mixture liquid. Furthermore, a 1.9 mol % chain transfer agent based on the total amount of the monomer, potassium persulfate (1.9 parts), and water (659 parts) were mixed to prepare an aqueous solution of a polymerization initiator. The monomer mixture liquid and the aqueous solution of a polymerization initiator were dropwise added to the reaction vessel in parallel over 60 minutes. The mixture was stirred for 30 minutes to carry out the reaction to manufacture resin particle 1. An appropriate amount of an 8 mol/L potassium hydroxide aqueous solution was added thereto to adjust the pH to 8.5, and an aqueous dispersion liquid of a resin particle 1 was obtained. The content (%) of the resin particle, the average particle size D_{E} (nm) of resin particle and glass transition temperature Tg (° C.) are shown in Table 4.

### Resin Particle 2

An aqueous dispersion liquid of a resin particle 3 with a resin particle content of 30.0% was obtained as in the above-described resin particle 1 aqueous dispersion liquid except that St (44.0 parts), AN (19.0 parts), 2EHA (28.0 parts), MAA (6.0 parts) and the reactive surfactant (3.0 parts) were used and that the chain transfer agent was not used. The content (%) of the resin particle, the average particle size D_{E} (nm) of resin particle and glass transition temperature Tg (° C.) are shown in Table 4.

### Resin Particle 3

Water (400 parts), St (12.0 parts), MMA (11.5 parts) and sodium styrenesulfonate (0.044 parts) were placed in a 500-mL separable flask. Nitrogen gas bubbling was carried out while stirring at 50 rpm, and the temperature was increased to 70° C. After stirring for 30 minutes, a polymerization initiator (potassium peroxodisulfate, manufactured by FUJIFILM Wako Pure Chemical Corporation, 0.8 parts) dissolved in water (20 parts) was added thereto. After reaction by stirring at 70° C. at 200 rpm for 8 hours, an appropriate amount of ion exchanged water was added thereto to obtain an aqueous dispersion liquid of a resin particle 3. The content (%) of the resin particle, the average particle size D_{E} (nm) of resin particle and glass transition temperature Tg (° C.) are shown in Table 4.

### Resin Particles 4 to 7

Commercially available aqueous dispersion liquids shown in Table 4 were used as the aqueous dispersion liquid of resin particles 4 to 7. The content (%) of the resin particle, the average particle size D_{E} (nm) of resin particle and glass transition temperature Tg (° C.) are shown in Table 4.

TABLE 4
Type of resin particle

| Resin | Resin particle- | Resin particle | D_{E} | Tg | |
|---|---|---|---|---|---|
| particle | forming resin | content (%) | (nm) | (° C.) | Note |
| 1 | Polystyrene resin | 30.0 | 220 | 61 | — |
| 2 | Acrylic resin | 30.0 | 160 | 53 | — |
| 3 | Acrylic resin | 30.0 | 200 | 98 | — |
| 4 | Urethane resin | 40.0 | 200 | 36 | Trade name “SUPERFLEX |
| | | | | | 860”, manufactured by DKS |
| | | | | | Co., Ltd. |
| 5 | Polyester resin | 40.0 | 122 | 67 | Trade name “VYLONAL MD- |
| | | | | | 2000”, manufactured by |
| | | | | | TOYOBO Co., Ltd. |
| 6 | Urethane resin | 35.0 | 40 | 41 | Trade name “SUPERFLEX |
| | | | | | 210”, manufactured by DKS |
| | | | | | Co., Ltd. |
| 7 | Vinyl chloride | 43.0 | 230 | −9 | Trade name “Vinyblan 271”, |
| | resin | | | | manufactured by Nissin |
| | | | | | Chemical Co., Ltd. |

### Preparation of Ink

Components (unit: %) shown in the middle rows of Tables 5-1 to 5-3 were mixed. The pH was adjusted within a range of 8 to 9 by adding potassium hydroxide (which is included in the amount of ion-exchanged water in Tables 5-1 to 5-3), followed by pressure filtration through a microfilter with a pore size of 5.0 m (manufactured by FUJIFILM Corporation) to prepare each ink. In Tables 5-1 to 5-3, “Acetylenol E100” is a trade name of a nonionic surfactant (acetylene glycol ethylene oxide adduct) manufactured by Kawaken Fine Chemicals Co., Ltd. The characteristics of the prepared inks are shown in the lower rows of Tables 5-1 to 5-3.

TABLE 5-1
Composition and characteristics of ink

| | Ink | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Type of | 1 | 2 | 3 | 4 | 1 | 1 | 1 | 1 | 5 | 6 | 7 | 8 |
| pigment | | | | | | | | | | | | |
| dispersion | | | | | | | | | | | | |
| liquid | | | | | | | | | | | | |
| Type of | 1 | 1 | 1 | 1 | 2 | 3 | 4 | 5 | 1 | 1 | 1 | 1 |
| resin | | | | | | | | | | | | |
| particle | | | | | | | | | | | | |
| Type of | — | — | — | — | — | — | — | — | — | — | — | — |
| water- | | | | | | | | | | | | |
| soluble | | | | | | | | | | | | |
| resin | | | | | | | | | | | | |
| Pigment | 35.2 | 35.2 | 35.2 | 35.2 | 35.2 | 35.2 | 35.2 | 35.2 | 35.2 | 35.2 | 35.2 | 35.2 |
| dispersion | | | | | | | | | | | | |
| liquid | | | | | | | | | | | | |
| Aqueous | 24.7 | 24.7 | 24.7 | 24.7 | 24.7 | 24.7 | 18.5 | 18.5 | 24.7 | 24.7 | 24.7 | 24.7 |
| dispersion | | | | | | | | | | | | |
| liquid of | | | | | | | | | | | | |
| resin | | | | | | | | | | | | |
| particle | | | | | | | | | | | | |
| Aqueous | | | | | | | | | | | | |
| liquid of | | | | | | | | | | | | |
| water- | | | | | | | | | | | | |
| soluble | | | | | | | | | | | | |
| resin | | | | | | | | | | | | |
| Glycerin | 2.0 | 2.0 | 2.0 | 2.0 | 2.0 | 2.0 | 2.0 | 2.0 | 2.0 | 2.0 | 2.0 | 2.0 |
| Ethylene | 7.0 | 7.0 | 7.0 | 7.0 | 7.0 | 7.0 | 7.0 | 7.0 | 7.0 | 7.0 | 7.0 | 7.0 |
| glycol | | | | | | | | | | | | |
| Acetylenol | 0.5 | 0.5 | 0.5 | 0.5 | 0.5 | 0.5 | 0.5 | 0.5 | 0.5 | 0.5 | 0.5 | 0.5 |
| E100 | | | | | | | | | | | | |
| Ion- | 30.6 | 30.6 | 30.6 | 30.6 | 30.6 | 30.6 | 36.8 | 36.8 | 30.6 | 30.6 | 30.6 | 30.6 |
| exchanged | | | | | | | | | | | | |
| water | | | | | | | | | | | | |
| Titanium | 13.4 | 13.4 | 13.4 | 13.4 | 13.4 | 13.4 | 13.4 | 13.4 | 13.4 | 13.4 | 13.4 | 13.4 |
| oxide | | | | | | | | | | | | |
| content C_{P} | | | | | | | | | | | | |
| (mass %) | | | | | | | | | | | | |
| Titanium | 3.2 | 3.2 | 3.2 | 3.2 | 3.2 | 3.2 | 3.2 | 3.2 | 3.2 | 3.2 | 3.2 | 3.2 |
| oxide | | | | | | | | | | | | |
| content V_{P} | | | | | | | | | | | | |
| (vol %) | | | | | | | | | | | | |
| Water- | 0.7 | 0.7 | 0.7 | 0.7 | 0.7 | 0.7 | 0.7 | 0.7 | 0.4 | 0.5 | 0.8 | 1.0 |
| soluble | | | | | | | | | | | | |
| resin | | | | | | | | | | | | |
| content C_{S} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.4 |
| particle | | | | | | | | | | | | |
| content C_{E} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.4 |
| particle | | | | | | | | | | | | |
| content V_{E} | | | | | | | | | | | | |
| (vol %) | | | | | | | | | | | | |
| Value of | 0.05 | 0.05 | 0.05 | 0.05 | 0.05 | 0.05 | 0.05 | 0.05 | 0.03 | 0.04 | 0.06 | 0.07 |
| C_{S}/C_{P} | | | | | | | | | | | | |
| (times) | | | | | | | | | | | | |
| Value of | 0.6 | 0.6 | 0.6 | 0.6 | 0.6 | 0.6 | 0.6 | 0.6 | 0.6 | 0.6 | 0.6 | 0.6 |
| C_{E}/C_{P} | | | | | | | | | | | | |
| (times) | | | | | | | | | | | | |
| Value of | 2.3 | 2.3 | 2.3 | 2.3 | 2.3 | 2.3 | 2.3 | 2.3 | 2.3 | 2.3 | 2.3 | 2.3 |
| V_{E}/V_{P} | | | | | | | | | | | | |
| (times) | | | | | | | | | | | | |
| | Ink | | | | | | | | | | | |
| | 13 | 14 | 15 | 16 | 17 | 18 | 19 | 20 | 21 | 22 | 23 | 24 |
| Type of | 9 | 10 | 11 | 12 | 13 | 14 | 15 | 16 | 17 | 18 | 19 | 20 |
| pigment | | | | | | | | | | | | |
| dispersion | | | | | | | | | | | | |
| liquid | | | | | | | | | | | | |
| Type of | 1 | 1 | 1 | 1 | 1 | 1 | 1 | 1 | 1 | 1 | 1 | 1 |
| resin | | | | | | | | | | | | |
| particle | | | | | | | | | | | | |
| Type of | — | — | — | — | — | — | — | — | — | — | — | — |
| water- | | | | | | | | | | | | |
| soluble | | | | | | | | | | | | |
| resin | | | | | | | | | | | | |
| Pigment | 35.2 | 35.2 | 35.2 | 35.2 | 35.2 | 35.2 | 35.2 | 35.2 | 35.2 | 35.2 | 35.2 | 35.2 |
| dispersion | | | | | | | | | | | | |
| liquid | | | | | | | | | | | | |
| Aqueous | 24.7 | 24.7 | 24.7 | 24.7 | 24.7 | 24.7 | 24.7 | 24.7 | 24.7 | 24.7 | 24.7 | 24.7 |
| dispersion | | | | | | | | | | | | |
| liquid of | | | | | | | | | | | | |
| resin | | | | | | | | | | | | |
| particle | | | | | | | | | | | | |
| Aqueous | | | | | | | | | | | | |
| liquid of | | | | | | | | | | | | |
| water- | | | | | | | | | | | | |
| soluble | | | | | | | | | | | | |
| resin | | | | | | | | | | | | |
| Glycerin | 2.0 | 2.0 | 2.0 | 2.0 | 2.0 | 2.0 | 2.0 | 2.0 | 2.0 | 2.0 | 2.0 | 2.0 |
| Ethylene | 7.0 | 7.0 | 7.0 | 7.0 | 7.0 | 7.0 | 7.0 | 7.0 | 7.0 | 7.0 | 7.0 | 7.0 |
| glycol | | | | | | | | | | | | |
| Acetylenol | 0.5 | 0.5 | 0.5 | 0.5 | 0.5 | 0.5 | 0.5 | 0.5 | 0.5 | 0.5 | 0.5 | 0.5 |
| E100 | | | | | | | | | | | | |
| Ion- | 30.6 | 30.6 | 30.6 | 30.6 | 30.6 | 30.6 | 30.6 | 30.6 | 30.6 | 30.6 | 30.6 | 30.6 |
| exchanged | | | | | | | | | | | | |
| water | | | | | | | | | | | | |
| Titanium | 13.4 | 13.4 | 13.4 | 13.4 | 13.4 | 13.4 | 13.4 | 13.4 | 13.4 | 13.4 | 13.4 | 13.4 |
| oxide | | | | | | | | | | | | |
| content C_{P} | | | | | | | | | | | | |
| (mass %) | | | | | | | | | | | | |
| Titanium | 3.2 | 3.2 | 3.2 | 3.2 | 3.2 | 3.2 | 3.2 | 3.2 | 3.2 | 3.2 | 3.2 | 3.2 |
| oxide | | | | | | | | | | | | |
| content V_{P} | | | | | | | | | | | | |
| (vol %) | | | | | | | | | | | | |
| Water- | 1.3 | 1.3 | 0.4 | 0.3 | 0.4 | 0.7 | 0.7 | 0.7 | 0.7 | 14.1 | 14.1 | 14.1 |
| soluble | | | | | | | | | | | | |
| resin | | | | | | | | | | | | |
| content C_{S} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.4 |
| particle | | | | | | | | | | | | |
| content C_{E} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.4 |
| particle | | | | | | | | | | | | |
| content V_{E} | | | | | | | | | | | | |
| (vol %) | | | | | | | | | | | | |
| Value of | 0.10 | 0.10 | 0.03 | 0.02 | 0.03 | 0.05 | 0.05 | 0.05 | 0.05 | 1.05 | 1.05 | 1.05 |
| C_{S}/C_{P} | | | | | | | | | | | | |
| (times) | | | | | | | | | | | | |
| Value of | 0.6 | 0.6 | 0.6 | 0.6 | 0.6 | 0.6 | 0.6 | 0.6 | 0.6 | 0.6 | 0.6 | 0.6 |
| C_{E}/C_{P} | | | | | | | | | | | | |
| (times) | | | | | | | | | | | | |
| Value of | 2.3 | 2.3 | 2.3 | 2.3 | 2.3 | 2.3 | 2.3 | 2.3 | 2.3 | 2.3 | 2.3 | 2.3 |
| V_{E}/V_{P} | | | | | | | | | | | | |
| (times) | | | | | | | | | | | | |

TABLE 5-2
Composition and characteristics of ink

| | Ink | | | | | | | | | | | |
|---|---|---|---|---|---|---|---|---|---|---|---|---|
| | 25 | 26 | 27 | 28 | 29 | 30 | 31 | 32 | 33 | 34 | 35 | 36 |
| Type of | 28 | 28 | 28 | 28 | 28 | 28 | 28 | 28 | 21 | 22 | 23 | 24 |
| pigment | | | | | | | | | | | | |
| dispersion | | | | | | | | | | | | |
| liquid | | | | | | | | | | | | |
| Type of | 1 | 1 | 1 | 1 | 1 | 1 | 1 | 1 | 1 | 1 | 1 | 1 |
| resin | | | | | | | | | | | | |
| particle | | | | | | | | | | | | |
| Type of | 1 | 2 | 3 | 4 | 5 | 6 | 7 | 8 | — | — | — | — |
| water- | | | | | | | | | | | | |
| soluble | | | | | | | | | | | | |
| resin | | | | | | | | | | | | |
| Pigment | 35.2 | 35.2 | 35.2 | 35.2 | 35.2 | 35.2 | 35.2 | 35.2 | 35.2 | 35.2 | 35.2 | 35.2 |
| dispersion | | | | | | | | | | | | |
| liquid | | | | | | | | | | | | |
| Aqueous | 24.7 | 24.7 | 24.7 | 24.7 | 24.7 | 24.7 | 24.7 | 24.7 | 24.7 | 24.7 | 24.7 | 24.7 |
| dispersion | | | | | | | | | | | | |
| liquid of | | | | | | | | | | | | |
| resin | | | | | | | | | | | | |
| particle | | | | | | | | | | | | |
| Aqueous | 1.8 | 2.0 | 2.0 | 2.0 | 2.0 | 2.0 | 2.0 | 2.0 | | | | |
| liquid of | | | | | | | | | | | | |
| water- | | | | | | | | | | | | |
| soluble | | | | | | | | | | | | |
| resin | | | | | | | | | | | | |
| Glycerin | 2.0 | 2.0 | 2.0 | 2.0 | 2.0 | 2.0 | 2.0 | 2.0 | 2.0 | 2.0 | 2.0 | 2.0 |
| Ethylene | 7.0 | 7.0 | 7.0 | 7.0 | 7.0 | 7.0 | 7.0 | 7.0 | 7.0 | 7.0 | 7.0 | 7.0 |
| glycol | | | | | | | | | | | | |
| Acetylenol | 0.5 | 0.5 | 0.5 | 0.5 | 0.5 | 0.5 | 0.5 | 0.5 | 0.5 | 0.5 | 0.5 | 0.5 |
| E100 | | | | | | | | | | | | |
| Ion- | 28.8 | 28.6 | 28.6 | 28.6 | 28.6 | 28.6 | 28.6 | 28.6 | 30.6 | 30.6 | 30.6 | 30.6 |
| exchanged | | | | | | | | | | | | |
| water | | | | | | | | | | | | |
| Titanium | 13.4 | 13.4 | 13.4 | 13.4 | 13.4 | 13.4 | 13.4 | 13.4 | 12.3 | 13.4 | 13.4 | 13.4 |
| oxide | | | | | | | | | | | | |
| content C_{P} | | | | | | | | | | | | |
| (mass %) | | | | | | | | | | | | |
| Titanium | 3.2 | 3.2 | 3.2 | 3.2 | 3.2 | 3.2 | 3.2 | 3.2 | 2.9 | 3.2 | 3.2 | 3.2 |
| oxide | | | | | | | | | | | | |
| content V_{P} | | | | | | | | | | | | |
| (vol %) | | | | | | | | | | | | |
| Water- | 1.1 | 1.2 | 1.2 | 1.2 | 1.1 | 1.2 | 1.2 | 1.2 | 0.0 | 8.8 | 1.6 | 1.6 |
| soluble | | | | | | | | | | | | |
| resin | | | | | | | | | | | | |
| content C_{S} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.4 |
| particle | | | | | | | | | | | | |
| content C_{E} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.4 |
| particle | | | | | | | | | | | | |
| content V_{E} | | | | | | | | | | | | |
| (vol %) | | | | | | | | | | | | |
| Value of | 0.08 | 0.09 | 0.09 | 0.09 | 0.08 | 0.09 | 0.09 | 0.09 | 0.00 | 0.66 | 0.12 | 0.12 |
| C_{S}/C_{P} | | | | | | | | | | | | |
| (times) | | | | | | | | | | | | |
| Value of | 0.6 | 0.6 | 0.6 | 0.6 | 0.6 | 0.6 | 0.6 | 0.6 | 0.6 | 0.6 | 0.6 | 0.6 |
| C_{E}/C_{P} | | | | | | | | | | | | |
| (times) | | | | | | | | | | | | |
| Value of | 2.3 | 2.3 | 2.3 | 2.3 | 2.3 | 2.3 | 2.3 | 2.3 | 2.6 | 2.3 | 2.3 | 2.3 |
| V_{E}/V_{P} | | | | | | | | | | | | |
| (times) | | | | | | | | | | | | |
| | Ink | | | | | | | | | | | |
| | 37 | 38 | 39 | 40 | 41 | 42 | 43 | 44 | 45 | 46 | 47 | 48 |
| Type of | 25 | 26 | 27 | 28 | 28 | 28 | 28 | 28 | 28 | 28 | 28 | 29 |
| pigment | | | | | | | | | | | | |
| dispersion | | | | | | | | | | | | |
| liquid | | | | | | | | | | | | |
| Type of | 1 | 1 | 1 | 1 | 1 | 1 | 1 | 1 | 1 | 1 | 1 | 6 |
| resin | | | | | | | | | | | | |
| particle | | | | | | | | | | | | |
| Type of | — | — | — | — | 9 | 10 | 11 | 12 | 13 | 14 | 15 | — |
| water- | | | | | | | | | | | | |
| soluble | | | | | | | | | | | | |
| resin | | | | | | | | | | | | |
| Pigment | 35.2 | 35.2 | 35.2 | 35.2 | 35.2 | 35.2 | 35.2 | 35.2 | 35.2 | 35.2 | 35.2 | 26.2 |
| dispersion | | | | | | | | | | | | |
| liquid | | | | | | | | | | | | |
| Aqueous | 24.7 | 24.7 | 24.7 | 24.7 | 24.7 | 24.7 | 24.7 | 24.7 | 24.7 | 24.7 | 24.7 | 21.4 |
| dispersion | | | | | | | | | | | | |
| liquid of | | | | | | | | | | | | |
| resin | | | | | | | | | | | | |
| particle | | | | | | | | | | | | |
| Aqueous | | | | | 2.0 | 2.0 | 2.0 | 2.0 | 2.0 | 2.0 | 2.0 | |
| liquid of | | | | | | | | | | | | |
| water- | | | | | | | | | | | | |
| soluble | | | | | | | | | | | | |
| resin | | | | | | | | | | | | |
| Glycerin | 2.0 | 2.0 | 2.0 | 2.0 | 2.0 | 2.0 | 2.0 | 2.0 | 2.0 | 2.0 | 2.0 | 2.0 |
| Ethylene | 7.0 | 7.0 | 7.0 | 7.0 | 7.0 | 7.0 | 7.0 | 7.0 | 7.0 | 7.0 | 7.0 | 7.0 |
| glycol | | | | | | | | | | | | |
| Acetylenol | 0.5 | 0.5 | 0.5 | 0.5 | 0.5 | 0.5 | 0.5 | 0.5 | 0.5 | 0.5 | 0.5 | 0.5 |
| E100 | | | | | | | | | | | | |
| Ion- | 30.6 | 30.6 | 30.6 | 30.6 | 28.6 | 28.6 | 28.6 | 28.6 | 28.6 | 28.6 | 28.6 | 42.9 |
| exchanged | | | | | | | | | | | | |
| water | | | | | | | | | | | | |
| Titanium | 13.4 | 13.4 | 13.4 | 13.4 | 13.4 | 13.4 | 13.4 | 13.4 | 13.4 | 13.4 | 13.4 | 10.0 |
| oxide | | | | | | | | | | | | |
| content C_{P} | | | | | | | | | | | | |
| (mass %) | | | | | | | | | | | | |
| Titanium | 3.2 | 3.2 | 3.2 | 3.2 | 3.2 | 3.2 | 3.2 | 3.2 | 3.2 | 3.2 | 3.2 | 2.4 |
| oxide | | | | | | | | | | | | |
| content V_{P} | | | | | | | | | | | | |
| (vol %) | | | | | | | | | | | | |
| Water- | 1.6 | 0.4 | 0.4 | 0.4 | 0.9 | 1.2 | 1.2 | 1.2 | 1.2 | 1.2 | 1.2 | 0.5 |
| soluble | | | | | | | | | | | | |
| resin | | | | | | | | | | | | |
| content C_{S} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.5 |
| particle | | | | | | | | | | | | |
| content C_{E} | | | | | | | | | | | | |
| (mass %) | | | | | | | | | | | | |
| Resin | 7.4 | 7.4 | 7.4 | 7.4 | 7.4 | 7.4 | 7.4 | 7.4 | 7.4 | 7.4 | 7.4 | 7.5 |
| particle | | | | | | | | | | | | |
| content V_{E} | | | | | | | | | | | | |
| (vol %) | | | | | | | | | | | | |
| Value of | 0.12 | 0.03 | 0.03 | 0.03 | 0.07 | 0.09 | 0.09 | 0.09 | 0.09 | 0.09 | 0.09 | 0.05 |
| C_{S}/C_{P} | | | | | | | | | | | | |
| (times) | | | | | | | | | | | | |
| Value of | 0.6 | 0.6 | 0.6 | 0.6 | 0.6 | 0.6 | 0.6 | 0.6 | 0.6 | 0.6 | 0.6 | 0.8 |
| C_{E}/C_{P} | | | | | | | | | | | | |
| (times) | | | | | | | | | | | | |
| Value of | 2.3 | 2.3 | 2.3 | 2.3 | 2.3 | 2.3 | 2.3 | 2.3 | 2.3 | 2.3 | 2.3 | 3.1 |
| V_{E}/V_{P} | | | | | | | | | | | | |
| (times) | | | | | | | | | | | | |

TABLE 5-3
Composition and characteristics of ink

| | Ink | | | | | | | | | | | | |
|---|---|---|---|---|---|---|---|---|---|---|---|---|---|
| | 49 | 50 | 51 | 52 | 53 | 54 | 55 | 56 | 57 | 58 | 59 | 60 | 61 |
| Type of | 29 | 30 | 31 | 32 | 33 | 34 | 35 | 36 | 37 | 38 | 44 | 44 | 44 |
| pigment | | | | | | | | | | | | | |
| dispersion | | | | | | | | | | | | | |
| liquid | | | | | | | | | | | | | |
| Type of | 7 | 6 | 6 | 6 | 6 | 6 | 6 | 6 | 6 | 6 | 6 | 6 | 6 |
| resin | | | | | | | | | | | | | |
| particle | | | | | | | | | | | | | |
| Type of | — | — | — | — | — | — | — | — | — | — | 1 | 2 | 3 |
| water- | | | | | | | | | | | | | |
| soluble | | | | | | | | | | | | | |
| resin | | | | | | | | | | | | | |
| Pigment | 26.2 | 26.2 | 26.2 | 26.2 | 26.2 | 26.2 | 26.2 | 26.2 | 26.2 | 26.2 | 26.2 | 26.2 | 26.2 |
| dispersion | | | | | | | | | | | | | |
| liquid | | | | | | | | | | | | | |
| Aqueous | 17.4 | 21.4 | 21.4 | 21.4 | 21.4 | 21.4 | 21.4 | 21.4 | 21.4 | 21.4 | 21.4 | 21.4 | 21.4 |
| dispersion | | | | | | | | | | | | | |
| liquid of | | | | | | | | | | | | | |
| resin | | | | | | | | | | | | | |
| particle | | | | | | | | | | | | | |
| Aqueous | | | | | | | | | | | 1.8 | 1.8 | 1.8 |
| liquid of | | | | | | | | | | | | | |
| water- | | | | | | | | | | | | | |
| soluble | | | | | | | | | | | | | |
| resin | | | | | | | | | | | | | |
| Glycerin | 2.0 | 2.0 | 2.0 | 2.0 | 2.0 | 2.0 | 2.0 | 2.0 | 2.0 | 2.0 | 2.0 | 2.0 | 2.0 |
| Ethylene | 7.0 | 7.0 | 7.0 | 7.0 | 7.0 | 7.0 | 7.0 | 7.0 | 7.0 | 7.0 | 7.0 | 7.0 | 7.0 |
| glycol | | | | | | | | | | | | | |
| Acetylenol | 0.5 | 0.5 | 0.5 | 0.5 | 0.5 | 0.5 | 0.5 | 0.5 | 0.5 | 0.5 | 0.5 | 0.5 | 0.5 |
| E100 | | | | | | | | | | | | | |
| Ion- | 46.9 | 42.9 | 42.9 | 42.9 | 42.9 | 42.9 | 42.9 | 42.9 | 42.9 | 42.9 | 41.1 | 41.1 | 41.1 |
| exchanged | | | | | | | | | | | | | |
| water | | | | | | | | | | | | | |
| Titanium | 10.0 | 10.0 | 10.0 | 10.0 | 10.0 | 10.0 | 10.0 | 10.0 | 10.0 | 10.0 | 10.0 | 10.0 | 10.0 |
| oxide | | | | | | | | | | | | | |
| content C_{P} | | | | | | | | | | | | | |
| (mass %) | | | | | | | | | | | | | |
| Titanium | 2.4 | 2.4 | 2.4 | 2.4 | 2.4 | 2.4 | 2.4 | 2.4 | 2.4 | 2.4 | 2.4 | 2.4 | 2.4 |
| oxide | | | | | | | | | | | | | |
| content V_{P} | | | | | | | | | | | | | |
| (vol %) | | | | | | | | | | | | | |
| Water- | 0.5 | 0.5 | 0.2 | 0.3 | 0.5 | 0.5 | 0.5 | 10.5 | 10.5 | 10.5 | 1.0 | 1.0 | 1.0 |
| soluble | | | | | | | | | | | | | |
| resin | | | | | | | | | | | | | |
| content C_{S} | | | | | | | | | | | | | |
| (mass %) | | | | | | | | | | | | | |
| Resin | 7.5 | 7.5 | 7.5 | 7.5 | 7.5 | 7.5 | 7.5 | 7.5 | 7.5 | 7.5 | 7.5 | 7.5 | 7.5 |
| particle | | | | | | | | | | | | | |
| content C_{E} | | | | | | | | | | | | | |
| (mass %) | | | | | | | | | | | | | |
| Resin | 7.5 | 7.5 | 7.5 | 7.5 | 7.5 | 7.5 | 7.5 | 7.5 | 7.5 | 7.5 | 7.5 | 7.5 | 7.5 |
| particle | | | | | | | | | | | | | |
| content V_{E} | | | | | | | | | | | | | |
| (vol %) | | | | | | | | | | | | | |
| Value of | 0.05 | 0.05 | 0.02 | 0.03 | 0.05 | 0.05 | 0.05 | 1.05 | 1.05 | 1.05 | 0.10 | 0.10 | 0.10 |
| C_{S}/C_{P} | | | | | | | | | | | | | |
| (times) | | | | | | | | | | | | | |
| Value of | 0.8 | 0.8 | 0.8 | 0.8 | 0.8 | 0.8 | 0.8 | 0.8 | 0.8 | 0.8 | 0.8 | 0.8 | 0.8 |
| C_{E}/C_{P} | | | | | | | | | | | | | |
| (times) | | | | | | | | | | | | | |
| Value of | 3.1 | 3.1 | 3.1 | 3.1 | 3.1 | 3.1 | 3.1 | 3.1 | 3.1 | 3.1 | 3.1 | 3.1 | 3.1 |
| V_{E}/V_{P} | | | | | | | | | | | | | |
| (times) | | | | | | | | | | | | | |

| | Ink | | | | | | | | | | | |
|---|---|---|---|---|---|---|---|---|---|---|---|---|
| | 62 | 63 | 64 | 65 | 66 | 67 | 68 | 69 | 70 | 71 | 72 | 73 |
| Type of | 44 | 44 | 44 | 39 | 40 | 41 | 42 | 43 | 44 | 44 | 44 | 44 |
| pigment | | | | | | | | | | | | |
| dispersion | | | | | | | | | | | | |
| liquid | | | | | | | | | | | | |
| Type of | 6 | 6 | 6 | 6 | 6 | 6 | 6 | 6 | 6 | 6 | 6 | 6 |
| resin | | | | | | | | | | | | |
| particle | | | | | | | | | | | | |
| Type of | 5 | 6 | 7 | — | — | — | — | — | — | 9 | 10 | 15 |
| water- | | | | | | | | | | | | |
| soluble | | | | | | | | | | | | |
| resin | | | | | | | | | | | | |
| Pigment | 26.2 | 26.2 | 26.2 | 26.2 | 26.2 | 26.2 | 26.2 | 26.2 | 26.2 | 26.2 | 26.2 | 26.2 |
| dispersion | | | | | | | | | | | | |
| liquid | | | | | | | | | | | | |
| Aqueous | 21.4 | 21.4 | 21.4 | 21.4 | 21.4 | 21.4 | 21.4 | 21.4 | 21.4 | 21.4 | 21.4 | 21.4 |
| dispersion | | | | | | | | | | | | |
| liquid of | | | | | | | | | | | | |
| resin | | | | | | | | | | | | |
| particle | | | | | | | | | | | | |
| Aqueous | 1.8 | 1.8 | 1.8 | | | | | | | 1.8 | 1.8 | 1.8 |
| liquid of | | | | | | | | | | | | |
| water- | | | | | | | | | | | | |
| soluble | | | | | | | | | | | | |
| resin | | | | | | | | | | | | |
| Glycerin | 2.0 | 2.0 | 2.0 | 2.0 | 2.0 | 2.0 | 2.0 | 2.0 | 2.0 | 2.0 | 2.0 | 2.0 |
| Ethylene | 7.0 | 7.0 | 7.0 | 7.0 | 7.0 | 7.0 | 7.0 | 7.0 | 7.0 | 7.0 | 7.0 | 7.0 |
| glycol | | | | | | | | | | | | |
| Acetylenol | 0.5 | 0.5 | 0.5 | 0.5 | 0.5 | 0.5 | 0.5 | 0.5 | 0.5 | 0.5 | 0.5 | 0.5 |
| E100 | | | | | | | | | | | | |
| Ion- | 41.1 | 41.1 | 41.1 | 42.9 | 42.9 | 42.9 | 42.9 | 42.9 | 42.9 | 41.1 | 41.1 | 41.1 |
| exchanged | | | | | | | | | | | | |
| water | | | | | | | | | | | | |
| Titanium | 10.0 | 10.0 | 10.0 | 9.2 | 10.0 | 10.0 | 10.0 | 10.0 | 10.0 | 10.0 | 10.0 | 10.0 |
| oxide | | | | | | | | | | | | |
| content C_{P} | | | | | | | | | | | | |
| (mass %) | | | | | | | | | | | | |
| Titanium | 2.4 | 2.4 | 2.4 | 2.2 | 2.4 | 2.4 | 2.4 | 2.4 | 2.4 | 2.4 | 2.4 | 2.4 |
| oxide | | | | | | | | | | | | |
| content V_{P} | | | | | | | | | | | | |
| (vol %) | | | | | | | | | | | | |
| Water- | 1.0 | 1.0 | 1.0 | 0.0 | 6.6 | 1.2 | 1.2 | 1.2 | 0.3 | 0.7 | 1.0 | 1.1 |
| soluble | | | | | | | | | | | | |
| resin | | | | | | | | | | | | |
| content C_{S} | | | | | | | | | | | | |
| (mass %) | | | | | | | | | | | | |
| Resin | 7.5 | 7.5 | 7.5 | 7.5 | 7.5 | 7.5 | 7.5 | 7.5 | 7.5 | 7.5 | 7.5 | 7.5 |
| particle | | | | | | | | | | | | |
| content C_{E} | | | | | | | | | | | | |
| (mass %) | | | | | | | | | | | | |
| Resin | 7.5 | 7.5 | 7.5 | 7.5 | 7.5 | 7.5 | 7.5 | 7.5 | 7.5 | 7.5 | 7.5 | 7.5 |
| particle | | | | | | | | | | | | |
| content V_{E} | | | | | | | | | | | | |
| (vol %) | | | | | | | | | | | | |
| Value of | 0.10 | 0.10 | 0.10 | 0.00 | 0.66 | 0.12 | 0.12 | 0.12 | 0.03 | 0.07 | 0.10 | 0.11 |
| C_{S}/C_{P} | | | | | | | | | | | | |
| (times) | | | | | | | | | | | | |
| Value of | 0.8 | 0.8 | 0.8 | 0.8 | 0.8 | 0.8 | 0.8 | 0.8 | 0.8 | 0.8 | 0.8 | 0.8 |
| C_{E}/C_{P} | | | | | | | | | | | | |
| (times) | | | | | | | | | | | | |
| Value of | 3.1 | 3.1 | 3.1 | 3.4 | 3.1 | 3.1 | 3.1 | 3.1 | 3.1 | 3.1 | 3.1 | 3.1 |
| V_{E}/V_{P} | | | | | | | | | | | | |
| (times) | | | | | | | | | | | | |

### Preparation of Reaction Liquid

The components (unit: %) shown in the upper row of Table 6 were mixed, and the mixture was pressure-filtered through a microfilter with a pore size of 5.0 m (manufactured by FUJIFILM Corporation) to prepare each reaction liquid. As the aqueous solution of cationic resin, poly(diallyldimethylammonium chloride)-containing aqueous solution (trade name “Unisence FPA100L” (manufactured by Senka Corporation, cationic resin content: 27.0%) was used. In Table 6, “Acetylenol E100” is a trade name of a nonionic surfactant (acetylene glycol ethylene oxide adduct) manufactured by Kawaken Fine Chemicals Co., Ltd. The characteristics of the prepared reaction liquid are shown in the lower row of Table 6.

TABLE 6
Composition and characteristics of reaction liquid

| | Reaction liquid | | | | | | | |
|---|---|---|---|---|---|---|---|---|
| | 1 | 2 | 3 | 4 | 5 | 6 | 7 | 8 |
| Magnesium sulfate heptahydrate | 16.8 | 5.9 | 9.8 | 23.6 | 16.8 | | | |
| Calcium nitrate tetrahydrate | | | | | | 19.5 | | |
| Aqueous solution of cationic resin | 0.2 | 0.2 | 0.2 | 0.2 | | 0.2 | 37.0 | |
| Succinic acid | | | | | | | | 10.0 |
| Glycerin | 7.0 | 7.0 | 7.0 | 7.0 | 7.0 | 7.0 | 7.0 | 7.0 |
| Ethylene glycol | 2.0 | 2.0 | 2.0 | 2.0 | 2.0 | 2.0 | 2.0 | 2.0 |
| Acetylenol E100 | 0.5 | 0.5 | 0.5 | 0.5 | 0.5 | 0.5 | 0.5 | 0.5 |
| Ion-exchanged water | 73.5 | 84.4 | 80.5 | 66.7 | 73.7 | 70.8 | 53.5 | 80.5 |
| Polyvalent metal ion concentration (mol/L) | 0.7 | 0.2 | 0.4 | 1.1 | 0.7 | 0.9 | 0.0 | 0.0 |
| Cationic resin content (%) | 0.05 | 0.05 | 0.05 | 0.05 | 0.00 | 0.05 | 9.99 | 0.00 |

### Evaluation

The inks and reaction liquids obtained above were evaluated for the following items. In the present disclosure, “AA”, “A” and “B” in the evaluation criteria of each item shown below are acceptable levels, and “C” is an unacceptable level. The evaluation results are shown in Tables 7 and 8.

### Recording of Image

An ink jet recording apparatus (trade name “PIXUS PRO-10S”, manufactured by CANON KABUSHIKI KAISHA) equipped with a recording head that ejects a liquid by the action of heat energy was provided. In the present Example, the recording duty of an image recorded using this ink jet recording apparatus under a condition of applying 8 ink droplets with a mass of 3.5 ng per droplet to a unit area of 1/600 inch× 1/600 inch is defined as 100%. Cartridges were filled with the ink and the reaction liquid of types shown in Tables 7 and 8, respectively, and were then set in the above ink jet recording apparatus. As the recording medium, a PET film (trade name “LLRPCF1372”, manufactured by Sakurai Co., Ltd., the water absorption amount from the start of contact to 30 msec^{1/2} is within a range of 0 mL/m² or more to 10 mL/m² or less in the Bristow method) was cut to an A4 size and used. The reaction liquid and the ink were ejected and applied to a recording medium in layers in this order from the recording head using the above recording apparatus to record a solid image of 50 mm×□50 mm. The recording duties of the reaction liquid and the ink are shown in Tables 6 and 7. Then, the image was dried and heated by applying warm air of heating temperatures shown in Tables 7 and 8 to the recording medium at an air speed of 25 m/s using a warm-air dryer (trade name “Multi-dryer HAS-17T”, manufactured by Kansai Electric Heat Corp.) to fix the image to the recording medium.

### Film Thickness Unevenness Suppression

A cut cross-section formed by cutting the recording medium on which an image was recorded was observed using a scanning electron microscope (trade name “5-4000”, manufactured by Hitachi, Ltd.), and the film thicknesses of the image at 30 points were measured. The standard deviation of the film thicknesses measured at 30 points was calculated, and the film thickness unevenness suppression of the image was evaluated according to the evaluation criteria shown below. The smaller the standard deviation, the more uniform the film thickness of the image and the more suppressed the unevenness.
AA: the standard deviation was less than 3.0;
A: the standard deviation was 3.0 or more to less than 3.5;
B: the standard deviation was 3.5 or more to less than 4.0; and
C: the standard deviation was 4.0 or more.

### Concealing Property

The concealing property of each image was evaluated by measuring and calculating the contrast ratio of a recorded image according to a method in accordance with ISO 2471:2008. In ISO 2471:2008, reflection coefficients are measured by backing the recording medium (paper) as a test object with a white plate and a black plate, respectively, and the contrast ratio is calculated by the following equation (C):

$$Contrast ratio ( \% ) = ( {R}_{0} / {R}_{∞} ) \times 100 , \qquad ( C )$$

$${R}_{0} : the reflection coefficient measured by backing with a black plate ; and$$

$${R}_{∞} : the reflection coefficient measured by backing with a white plate .$$

In the present Example, in accordance with this method, the contrast ratio of the recorded image was measured and calculated using contrast ratio test paper (white plate and black plate, manufactured by TP Giken Co., Ltd., with inspection certificate from Japan Paint Inspection and testing Association). The concealing property of the image was evaluated according to the following evaluation criteria:
AA: the contrast ratio was 60% or more;
A: the contrast ratio was 50% or more to less than 60%;
B: the contrast ratio was 40% or more to less than 50%; and
C: the contrast ratio was less than 40%.

TABLE 7
Evaluation condition and evaluation result

| | | Evaluation conditions | | | | | | Evaluation result | |
|---|---|---|---|---|---|---|---|---|---|
| | | | | Recording duty (%) | | | | Suppression | |
| | | Type of | Type | Reaction | Ink | Value of | Heating | of film | |
| | | reaction | of | liquid | V_{I} | V_{R}/V_{I} | temperature | thickness | Concealing |
| | | liquid | ink | V_{R} (%) | (%) | (times) | (° C.) | unevenness | property |
| Example | 1 | 1 | 1 | 40 | 200 | 0.20 | 100 | AA | AA |
| | 2 | 1 | 2 | 40 | 200 | 0.20 | 100 | AA | AA |
| | 3 | 1 | 3 | 40 | 200 | 0.20 | 100 | AA | AA |
| | 4 | 1 | 4 | 40 | 200 | 0.20 | 100 | AA | AA |
| | 5 | 1 | 5 | 40 | 200 | 0.20 | 100 | AA | AA |
| | 6 | 1 | 6 | 40 | 200 | 0.20 | 200 | AA | AA |
| | 7 | 1 | 7 | 40 | 200 | 0.20 | 100 | AA | AA |
| | 8 | 1 | 8 | 40 | 200 | 0.20 | 100 | AA | AA |
| | 9 | 1 | 9 | 40 | 200 | 0.20 | 100 | AA | AA |
| | 10 | 1 | 10 | 40 | 200 | 0.20 | 100 | AA | AA |
| | 11 | 1 | 11 | 40 | 200 | 0.20 | 100 | AA | AA |
| | 12 | 1 | 12 | 40 | 200 | 0.20 | 100 | AA | AA |
| | 13 | 1 | 13 | 40 | 200 | 0.20 | 100 | AA | AA |
| | 14 | 1 | 14 | 40 | 200 | 0.20 | 100 | AA | AA |
| | 15 | 1 | 15 | 40 | 200 | 0.20 | 100 | AA | AA |
| | 16 | 1 | 16 | 40 | 200 | 0.20 | 100 | A | AA |
| | 17 | 1 | 17 | 40 | 200 | 0.20 | 100 | AA | AA |
| | 18 | 1 | 18 | 40 | 200 | 0.20 | 100 | AA | AA |
| | 19 | 1 | 19 | 40 | 200 | 0.20 | 100 | A | A |
| | 20 | 1 | 20 | 40 | 200 | 0.20 | 100 | AA | AA |
| | 21 | 1 | 21 | 40 | 200 | 0.20 | 100 | AA | AA |
| | 22 | 1 | 22 | 40 | 200 | 0.20 | 100 | A | A |
| | 23 | 1 | 23 | 40 | 200 | 0.20 | 100 | A | AA |
| | 24 | 1 | 24 | 40 | 200 | 0.20 | 100 | A | AA |
| | 25 | 1 | 25 | 40 | 200 | 0.20 | 100 | A | AA |
| | 26 | 1 | 26 | 40 | 200 | 0.20 | 100 | A | B |
| | 27 | 1 | 27 | 40 | 200 | 0.20 | 100 | A | AA |
| | 28 | 1 | 28 | 40 | 200 | 0.20 | 100 | A | AA |
| | 29 | 1 | 29 | 40 | 200 | 0.20 | 100 | A | AA |
| | 30 | 1 | 30 | 40 | 200 | 0.20 | 100 | A | B |
| | 31 | 1 | 31 | 40 | 200 | 0.20 | 100 | B | A |
| | 32 | 1 | 32 | 40 | 200 | 0.20 | 100 | B | A |
| | 33 | 2 | 1 | 40 | 200 | 0.20 | 100 | A | AA |
| | 34 | 3 | 1 | 40 | 200 | 0.20 | 100 | AA | AA |
| | 35 | 4 | 1 | 40 | 200 | 0.20 | 100 | AA | AA |
| | 36 | 5 | 1 | 40 | 200 | 0.20 | 100 | A | AA |
| | 37 | 6 | 1 | 40 | 200 | 0.20 | 100 | A | A |
| | 38 | 1 | 1 | 10 | 200 | 0.05 | 100 | A | B |
| | 39 | 1 | 1 | 20 | 200 | 0.10 | 100 | AA | AA |
| | 40 | 1 | 1 | 120 | 200 | 0.60 | 100 | AA | AA |
| | 41 | 1 | 1 | 160 | 200 | 0.80 | 100 | AA | AA |
| | 42 | 1 | 1 | 180 | 200 | 0.90 | 100 | A | B |
| Comparative | 1 | 1 | 33 | 40 | 200 | 0.20 | 100 | C | C |
| Example | 2 | 1 | 34 | 40 | 200 | 0.20 | 100 | C | C |
| | 3 | 1 | 35 | 40 | 200 | 0.20 | 100 | C | C |
| | 4 | 1 | 36 | 40 | 200 | 0.20 | 100 | C | C |
| | 5 | 1 | 37 | 40 | 200 | 0.20 | 100 | C | C |
| | 6 | 1 | 38 | 40 | 200 | 0.20 | 100 | C | C |
| | 7 | 1 | 39 | 40 | 200 | 0.20 | 100 | C | C |
| | 8 | 1 | 40 | 40 | 200 | 0.20 | 100 | C | C |
| | 9 | 1 | 41 | 40 | 200 | 0.20 | 100 | C | C |
| | 10 | 1 | 42 | 40 | 200 | 0.20 | 100 | C | C |
| | 11 | 1 | 43 | 40 | 200 | 0.20 | 100 | C | C |
| | 12 | 1 | 44 | 40 | 200 | 0.20 | 100 | C | C |
| | 13 | 1 | 45 | 40 | 200 | 0.20 | 100 | C | C |
| | 14 | 1 | 46 | 40 | 200 | 0.20 | 100 | C | C |
| | 15 | 1 | 47 | 40 | 200 | 0.20 | 100 | C | C |
| | 16 | — | 1 | 0 | 200 | 0.00 | 100 | C | C |
| | 17 | 7 | 1 | 40 | 200 | 0.20 | 100 | C | C |
| | 18 | 8 | 1 | 40 | 200 | 0.20 | 100 | C | C |

TABLE 8
Evaluation condition and evaluation result

| | | Evaluation condition | | | | | | |
|---|---|---|---|---|---|---|---|---|
| | | | | Recording duty (%) | | | | Evaluation result |
| | | Type of | Type | Reaction | | Value of | Heating | Suppression of |
| | | reaction | of | liquid | Ink | V_{R}/V_{I} | temperature | film thickness |
| | | liquid | ink | V_{R}(%) | V_{I}(%) | (times) | (° C.) | unevenness |
| Example | 43 | 1 | 48 | 40 | 200 | 0.20 | 100 | AA |
| | 44 | 1 | 49 | 40 | 200 | 0.20 | 100 | AA |
| | 45 | 1 | 50 | 40 | 200 | 0.20 | 100 | AA |
| | 46 | 1 | 51 | 40 | 200 | 0.20 | 100 | A |
| | 47 | 1 | 52 | 40 | 200 | 0.20 | 100 | AA |
| | 48 | 1 | 53 | 40 | 200 | 0.20 | 100 | AA |
| | 49 | 1 | 54 | 40 | 200 | 0.20 | 100 | A |
| | 50 | 1 | 55 | 40 | 200 | 0.20 | 100 | AA |
| | 51 | 1 | 56 | 40 | 200 | 0.20 | 100 | A |
| | 52 | 1 | 57 | 40 | 200 | 0.20 | 100 | A |
| | 53 | 1 | 58 | 40 | 200 | 0.20 | 100 | A |
| | 54 | 1 | 59 | 40 | 200 | 0.20 | 100 | A |
| | 55 | 1 | 60 | 40 | 200 | 0.20 | 100 | B |
| | 56 | 1 | 61 | 40 | 200 | 0.20 | 100 | A |
| | 57 | 1 | 62 | 40 | 200 | 0.20 | 100 | A |
| | 58 | 1 | 63 | 40 | 200 | 0.20 | 100 | B |
| | 59 | 1 | 64 | 40 | 200 | 0.20 | 100 | A |
| | 60 | 2 | 48 | 40 | 200 | 0.20 | 100 | A |
| | 61 | 3 | 48 | 40 | 200 | 0.20 | 100 | AA |
| | 62 | 5 | 48 | 40 | 200 | 0.20 | 100 | A |
| | 63 | 6 | 48 | 40 | 200 | 0.20 | 100 | A |
| | 64 | 1 | 48 | 10 | 200 | 0.05 | 100 | A |
| | 65 | 1 | 48 | 20 | 200 | 0.10 | 100 | AA |
| | 66 | 1 | 48 | 160 | 200 | 0.80 | 100 | AA |
| | 67 | 1 | 48 | 180 | 200 | 0.90 | 100 | A |
| Comparative | 19 | 1 | 65 | 40 | 200 | 0.20 | 100 | C |
| Example | 20 | 1 | 66 | 40 | 200 | 0.20 | 100 | C |
| | 21 | 1 | 67 | 40 | 200 | 0.20 | 100 | C |
| | 22 | 1 | 68 | 40 | 200 | 0.20 | 100 | C |
| | 23 | 1 | 69 | 40 | 200 | 0.20 | 100 | C |
| | 24 | 1 | 70 | 40 | 200 | 0.20 | 100 | C |
| | 25 | 1 | 71 | 40 | 200 | 0.20 | 100 | C |
| | 26 | 1 | 72 | 40 | 200 | 0.20 | 100 | C |
| | 27 | 1 | 73 | 40 | 200 | 0.20 | 100 | C |
| | 28 | — | 48 | 40 | 200 | 0.20 | 100 | C |
| | 29 | 7 | 48 | 40 | 200 | 0.20 | 100 | C |
| | 30 | 8 | 48 | 40 | 200 | 0.20 | 100 | C |

According to the present disclosure, an ink set for ink jet recording that can record a white image with suppressed film thickness unevenness can be provided. In addition, according to the present disclosure, an ink jet recording method and ink jet recording apparatus using this ink set can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-203847, filed Nov. 22, 2024 and No. 2025-177996, filed Oct. 22, 2025, which are hereby incorporated by reference herein in their entirety.

What is claimed is:

1. An ink set for ink jet recording comprising:
a white aqueous ink containing titanium oxide and a resin particle; and
a reaction liquid containing a reactant that reacts with the aqueous ink, wherein
the aqueous ink further comprises a water-soluble resin including a unit having an acidic group,
a proportion (mol %) of the unit having an acidic group in the water-soluble resin is 60.0 mol % or more, and the unit having an acidic group includes a unit having a plurality of carboxylic acid groups, and
the reactant comprises a polyvalent metal salt.

2. The ink set according to claim 1, wherein a mass ratio of the content (mass %) of the water-soluble resin to the content (mass %) of the titanium oxide in the aqueous ink is 0.03 times or more.

3. The ink set according to claim 1, wherein the unit having a plurality of carboxylic acid groups comprises a unit derived from a dicarboxylic acid compound, and a proportion (mol %) of the unit derived from a dicarboxylic acid compound in the unit having a plurality of carboxylic acid groups is 7.5 mol % or more.

4. The ink set according to claim 3, wherein the dicarboxylic acid compound is maleic acid.

5. The ink set according to claim 1, wherein the water-soluble resin is a resin dispersant that disperses the titanium oxide.

6. The ink set according to claim 1, wherein a concentration (mol/L) of a metal ion derived from the polyvalent metal salt in the reaction liquid is 0.4 mol/L or more.

7. The ink set according to claim 1, wherein the reactant further comprises a cationic resin.

8. The ink set according to claim 1, wherein the polyvalent metal salt is magnesium sulfate.

9. The ink set according to claim 1, wherein the titanium oxide has an average primary particle size D_{P0} (nm) of 150 nm or less,
the resin particle has a 50% cumulative particle size D_{E} (nm) of 100 nm or more to 400 nm or less in a volume-based particle size distribution, and
a volume ratio of a content (vol %) of the resin particle to a content (vol %) of the titanium oxide in the aqueous ink is 1.3 times or more to 5.0 times or less.

10. An ink jet recording method comprising:
a step of ejecting and applying an ink and a reaction liquid from a recording head of an ink jet system to a recording medium, wherein
the ink and the reaction liquid comprises the aqueous ink and the reaction liquid included in the ink set according to claim 1.

11. The ink jet recording method according to claim 10, further comprising:
a drying step of blowing air to the recording medium applied with the ink and the reaction liquid to dry at least a part of the liquid component on the recording medium.

12. The ink jet recording method according to claim 10, wherein a mass ratio of the application amount of the reaction liquid per unit area of the recording medium to the application amount of the aqueous ink is 0.10 times or more to 0.80 times or less.

13. The ink jet recording method according to claim 10, further comprising:
a heating step of heating the recording medium applied with the aqueous ink and the reaction liquid.

14. The ink jet recording method according to claim 10, wherein a water absorption amount of the recording medium from the start of contact to 30 msec^{1/2} is 10 mL/m² or less in the Bristow method.

15. An ink jet recording apparatus comprising:
an ink;
a reaction liquid; and
a recording head of an ink jet system for ejecting the ink and the reaction liquid, wherein
the ink and the reaction liquid comprises the aqueous ink and the reaction liquid included in the ink set according to claim 1.
